(19) United States
(12) Patent Application Publication
(10) Pub. No.: US 2011/0068575 A1
(43) Pub. Date: Mar. 24, 2011

(54) Hybrid integrated cogeneration system and method

(76) Inventor: Fikret M. Zabtcioglu, Istanbul (TR)

(21) Appl. No.: 12/880,194

(22) Filed: Sep. 13, 2010

(30) Foreign Application Priority Data
Sep. 16, 2009 (CA) 2680571

(51) Int. Cl. F01K 17/02; F24H 7/00; F03G 6/00

(52) U.S. Cl. 290/2; 126/400; 60/641.8

(57) ABSTRACT

A system and method is provided for converting electrical energy input provided by a renewable prime energy into efficient thermo-dynamic energy for cogeneration purposes, activated by the main infrared radiation means and an energy density increasing means functioning synergistically. A closely approximated ideal blackbody condition therein, is utilized to heat the (TES,) resulting in a highly stable total kinetic energy (TES) mass. Another section provides an energy density increasing means. Steam generates power and then heats residential or commercial buildings. Service hot-water and air conditioning is also provided. The system can be an auxiliary system for other power plants increasing efficiency. In the second embodiment, higher capacity low cost electricity generation enables efficient power cogeneration. A zero emission cogeneration system that includes a fast energy density increasing feature and central heating means, and second embodiment plant with high capacity cogeneration; are presented as what are new in the art.

### CROSS-REFERENCE TO RELATED APPLICATIONS

This application claims priority to Canada patent application 2,680,571, filed 16 Sep. 2009, which is hereby incorporated by reference herein.

### TECHNICAL FIELD

In the field of cogeneration (CHP) systems and more particularly to a new zero emission triple integrated cogeneration system. The heating system is combined with a chilled-water central air conditioner to provide a triple integrated system with air conditioning, water based central heating or forced air based heating for existing forced air infrastructure and service hot-water. A second embodiment relates to a higher capacity triple integrated system cogeneration plant with zero emission.

### BACKGROUND ART

Housing apartment units and multi-family units usually use a central heat source such as a boiler or a forced-air system using gas fired or electric resistance furnaces for space heating. All these systems are mostly energy inefficient.

In order to solve these energy inefficiencies, different methods have been proposed. For example, a heating system is disclosed to provide an improvement in the combined configuration for better efficiency, by Talbert et al (U.S. Pat. No. 6,109,339) that discloses a triple integrated system to provide room air heating, and cooling and domestic hot water.

In order to utilize cogeneration and to be able to respond to a plurality of different demands of thermal energy, a cogeneration system apparatus is disclosed by Togawa, et al. (U.S. Pat. No. 6,290,142) including an improvement in hot-water storage and re-heating of hot water, that enables it to respond to two different thermal loads.

With respect to space heating, combustion gases from direct air heating are used to heat a water tank. Doherty (U.S. Pat. No. 2,354,507) and Biggs (U.S. Pat. No. 5,361,751) both use warm combustion gases for the space heating, to heat potable water in a water tank. Due to the need for dual burners, such systems are large size and therefore are costlier. Clawson (U.S. Pat. No. 5,046,478) uses a combustion gas heat exchanger to heat a potable water to be used for air heating. Woodin (U.S. Pat. No. 4,848,416) discloses an instantaneous heat exchanger.

The demand for highly efficient and low cost cogeneration is increasing world-wide. In the last decade of the century, more than 100 billion watts of new electric generating capacity will be needed in the U.S. and greater than 500 GW (e) will be needed in the rest of the world. Unless there is a widespread applicable technological improvement, a very conservative estimate predicts that world-wide power related CO2 emission would rise more than 60 percent from 1997 by 2020. Warnings are coming from respectable U.S. and international scientific institutions about serious threats on ecosystems. The global climate change-breakdown will cause great economic damages; substantial economic losses have already occurred as ecosystems have started to fail. Based on the UK Meteorological Office data, since the beginning of the industrial age, up to the year 2000, significant rises in average temperatures occurred within a 140 years period; since the year 1860, being indicative that within next 140 years temperature increases could be exponential. Therefore, the European Union Commission aims to double the contribution of combined heating and power (CHP) solutions from 9 percent to at least 18 percent by 2010. The new climate campaign, which is gathering momentum as the current world economic crisis has surfaced, and a recent report by the Oak Ridge National Laboratory prove that large scale international investment into renewable energy systems would create a new economy which would generate large scale new employment throughout the world, and nearly one million highly skilled new jobs in the U.S.A. alone.

Each year 17 million vehicles are manufactured in the U.S. further increasing the energy demand. The electric-battery vehicle is the future in the automotive sector and electrical power driven economy requires an inexpensive source of electricity.

The trend indicates that eventually there will be a synergy of conventional technologies with proven high technologies to improve renewable energy output. Only this will enable hybrid-renewable energy systems of highest efficiency and the lowest cost production. This system aims to lead this trend by having operational renewable energy input from relatively few wind generators and few solar panels for this innovation.

Most important central heating performance measurements are: a. Thermal load density that is preferably high, and; b. Annual load factor; that is high. A high load density is needed in order to cover the capital investment of the transmission and distribution system that constitutes the majority of the capital cost. The yearly load factor is important because the total system is capital intensive.

Central heating systems are best for: 1. Industrial complexes; 2. Populated urban areas; 3. High density building clusters with high thermal loads: Central heating is best suited for areas that have high building and population densities—where the climate is cold; and, 4. Where the efficiency of insulation can be maximized.

End user priorities are reliability, long term low operational costs and reasonable price and compactness for onsite generation. Prior art cogeneration and central heating systems developed are of two main types: Those that are based on a conventional combustion means with high energy density and related heat transfer mechanisms and those based on a renewable energy source with low energy densities.

Energy consumed in U.S. residences for space heating-cooling accounts for 46 percent of all residential energy consumption. Service water-heating accounts for an additional 14 percent. This is a total of 60 percent for residential needs. That is, 60 percent of all energy consumed is of low energy quality type of utilization. Hence, there is need for cogeneration to be applied as widespread as possible, as it is more efficient; thermo-dynamic energy is not converted back from the electrical power generated, nor is heat wasted.

Operational cost is related to: 1. Energy type; fossil fuel—burner type or renewable type; 2. Heat transfer efficiency; 3. Insulation type and efficiency; and, 4. Cogeneration-CHP efficiency.

### SUMMARY OF INVENTION

From the foregoing, it may be appreciated that a need has arisen for a system and method for a cogeneration system and triple integrated system with air conditioning, central heating and service hot-water that avoids energy inefficiencies of the prior art.

It is an object of the present invention to provide a cogeneration apparatus capable of supplying thermodynamic energy efficiently to satisfy a plurality of different energy demands.

It is another object of the present invention to provide as a first feature of the invention, a system that ideally receives operational energy input from a low cost renewable prime energy source, such as wind and solar, but can also get operational energy from the utility grid. The system can also be paralleled to the utility grid for electrical energy output, thereby also increases the resiliency of the national energy infrastructure by offsetting transmission loses and limiting congestion. It is recommended to utilize existing wind farms for operational energy input or small capacity wind or solar energy input to be integrated to the invention system. Hence, for both for wind and solar, a large energy surplus gets stored.

It is another object of the present invention to provide as a second feature of the present invention, at least a set of infrared radiation members to provide infrared radiation as thermo-dynamic energy for the molten salt containing TES volume through a special enclosure that closely approximates an ideal blackbody container condition therein which results in a high stability total kinetic energy and stable average kinetic energy TES.

It is another object of the present invention to provide as a third feature of the invention, to establish a stable TES that enables high efficiency capacity utilization within a much shorter period relative to prior art systems to reach their most efficient system capacity utilization, with a substantially shorter initial power load period.

It is another object of the present invention as a fourth feature of the invention, to secure and keep the system functional with a secondary backup means that is always ready to backup the main thermo-dynamic energy means if it fails or when it is under maintenance.

It is another object of the present invention to provide as a fifth feature of the invention, wherein at least one cylindrical container, in which the thermo-dynamic energy of the working gas gets intensified within cylindrical volume quickly; and the energy density level increasing means becomes comparable to combustion based systems of comparable capacity in energy density level.

It is another object of the present invention to provide as a sixth feature of the present invention, a total TES molten salt mass that is greater by mass than the total working gas mass by a certain proportion, which is used to heat the working gas, to maximize thermo-dynamic stability of the TES.

It is another object of the present invention to provide as a seventh feature of the present invention, several steam turbines that utilize the high pressure steam generated to generate electrical energy and the working gas passing the turbines is circulated and utilized for central heating of residential and/or commercial premises.

It is another object of the present invention to provide as a eighth feature of the invention, a service hot water storage tank that heats service hot water and a hot oil storage tank for drawing heat to heat the refrigerant coils for the central air conditioning which are circulated therein, both tanks are heated by the waste heat from the thermal storage volume to provide a triple integrated system, providing a high total system efficiency throughout all seasons.

It is another object of the present invention to provide as a ninth feature of the present invention, to enable optimal distribution of working gas between the steam turbine power generation and the central heating.

It is another object of the present invention to provide, as a tenth feature of the present invention, a TES volume that enables flexibility of using different, alternative types of thermal storage materials that can be used and that are easy to maintain, overhaul, drain out, change and refill.

In the second embodiment, it is an object of the invention to provide as an eleventh object, to enable modular capacity increase for higher capacity cogeneration.

It is another object of the present invention to provide as an twelfth feature, a system that achieves a minimized waste heat system and therefore, provides a zero thermal pollution system; there is no combustion and no exhaust-no exhaust heat loss, therefore the system is ideal for the international greenhouse gases trading scheme.

It is another object of the present invention to provide as a thirteenth feature, an invention system that enables high energy quality utilization. Thermal energy generated is utilized directly as thermal energy for central heating and air conditioning.

It is another object of the present invention to provide as a fourteenth feature of the system, a system that provides power cogeneration which provides very high flexibility in terms of enabling different sizes and a wide range of capacity scalability.

It is another object of the present invention to provide as a fifteenth feature of this cogeneration system, of which the rated capacity to run on the highest capacity factor operation condition does not entail high economic and environmental opportunity costs and is independent of external variables and constraints like; ideal geographic locations with best sunny or windy conditions, ideal ebb and tide, day-night cycles, a need for large areas of land for the installation as in large area solar panels and large wind turbine farms, scarcity of fuels and unstable fuel prices, pollution control costs as in combustion plants, erosion and loss of valuable land, as in flooding of land for hydroelectric dams, tradeoff of degrading of valuable farming soil as in bio-fuels. That is, this system can avoid a substantial part of these high economic and externality costs by eliminating majority of these means.

It is another object of the present invention to provide as a sixteenth feature of the system, a wear-resistant cogeneration system that by eliminating and not having moving components-friction or combustion chambers as the main energy generation means, thereby also eliminates the green-house gas emissions as a zero emission system and is compatible with the 350 ppm CO2 objective, and has high durability and longer product life cycle.

It is another object of the present invention to provide as a seventeenth feature of the present invention to be subject of a relatively low cost OEM or subcontracted manufacturing and can be compatible to existing central residential and commercial heating and power generation, in technical means and labor and accordingly is then subject of reasonable prices of sale to the consuming and operating entities and end users, despite high profit margins on system sales and also enables high operational profit margins, thereby makes said cogeneration and the second embodiment of cogeneration of power and central heating plant to provide significant economic gains to all energy sectors and end users.

It is another object of the present invention to provide as a eighteenth feature of the invention, a system that provides OEM power generation, thermo-dynamic processing engineering companies the flexibility to choose different means to integrate the system with process heat or other industrial processes—by integrating related devices to this system and which can utilize the high stability thermo-dynamic base of this invention.

It is another object of the present invention to provide as a nineteenth feature of the invention, a system that does not have moving parts like pistons or combustion related volumes, pressure vessels, therefore the system operates without vibration and is very silent.

It is another object of the present invention to provide as a twentieth feature of the invention, to keep the main system technical features secret and make these sections accessible to only expert company personnel and make it tamper proof and inaccessible to others.

The objects of the current invention will be evident as depicted by the drawings.

### BRIEF DESCRIPTION OF DRAWINGS

FIG. 1 is a cross sectional depiction of the entire system that is made of at least one unit with a set of infrared radiation providing emitters that radiate into a closed container which approximates a blackbody container condition therein and this volume is in contact with one TES volume that is located above the infrared radiation closed container. Cross section reference lines A, B, C, D are for FIGS. 5, 6, 7, 8 of top closure removed views for in depth view from top. Backup energy input also depicted.

FIG. 2 is a cross sectional view of the system as depicted when infrared radiation input occurs through the main means that provides thermo-dynamic energy to the double surface container that has an atomic and molecular structure that maximizes absorption below the TES.

FIG. 3 is a cross sectional view of the system unit, it shows the TES molten salt volume, receiving thermo-dynamic energy through the double surface container; wherein the total kinetic energy gets stabilized.

FIG. 4 is a cross sectional view of system unit, TES volume side, shows one of the triple integrated system components of service hot water tank and sections—as integrated and located around one half of the TES volume enclosure cylindrical external surface area. Also shown is water based flow and central heating of premises.

FIG. 5 is a top view with top closure of one TES volume completely removed showing the molten salt TES volume with the working gas pipe circulating within the molten salt TES along the cross section A.

FIG. 6 is a top view with top closure of one TES volume completely removed showing the thermo-dynamic energy emitting double surface container surface area below the molten salt containing TES, along cross section B.

FIG. 7 is a top view with top closure of one TES volume completely removed showing concentric ring area surface to which secondary backup infrared radiation emitters provide radiation upon, along cross section C.

FIG. 8 is a top plan view with top closure-frame completely removed of one TES unit and the energy density increasing means container on top not shown and which is viewed from top showing the circular secondary backup infrared radiation emitter, surrounding the main means of the infrared radiation emitter members that are shown at the center, along cross section D.

FIG. 9 shows in top plan view four units combination as the modularly enlarged capacity system, with only one energy density increasing means cylindrical container, likewise the system can be modularly enlarged with only two units combined, with one larger energy density increasing cylindrical container, transmission and distribution system is common to all four, two units system not depicted.

FIG. 10 is a cross sectional view of the alternative central forced air distribution duct, if forced air is chosen instead of water based radiator system.

FIG. 11 is a top view of the TES top section with cylindrical energy increasing means container located above the TES, showing the alternative viewing direction depicted in next drawing of FIG. 13, to the direction along 107-107.

FIG. 12 is the cross sectional view of the cylindrical container volume, along the line 107-107. It shows the working gas spiral pipe section that absorbs infrared radiation, with high absorption coated paint located at the center of the cylindrical container, where the energy density gets increased by infrared radiation devices.

FIG. 13 is the focused depiction of the container that closely approximates blackbody container condition.

FIG. 14 is the cross sectional and three dimensional perspective view combination showing how the small inlet channels reach the middle molten salt volume of the circular pipe.

FIG. 15, shows how the infrared radiation emitter members and the secondary backup radiation emitters and the infrared radiation application volume below the TES, are contained and made tamper proof and inaccessible to unauthorized people.

### LIST OF REFERENCE NUMERALS USED

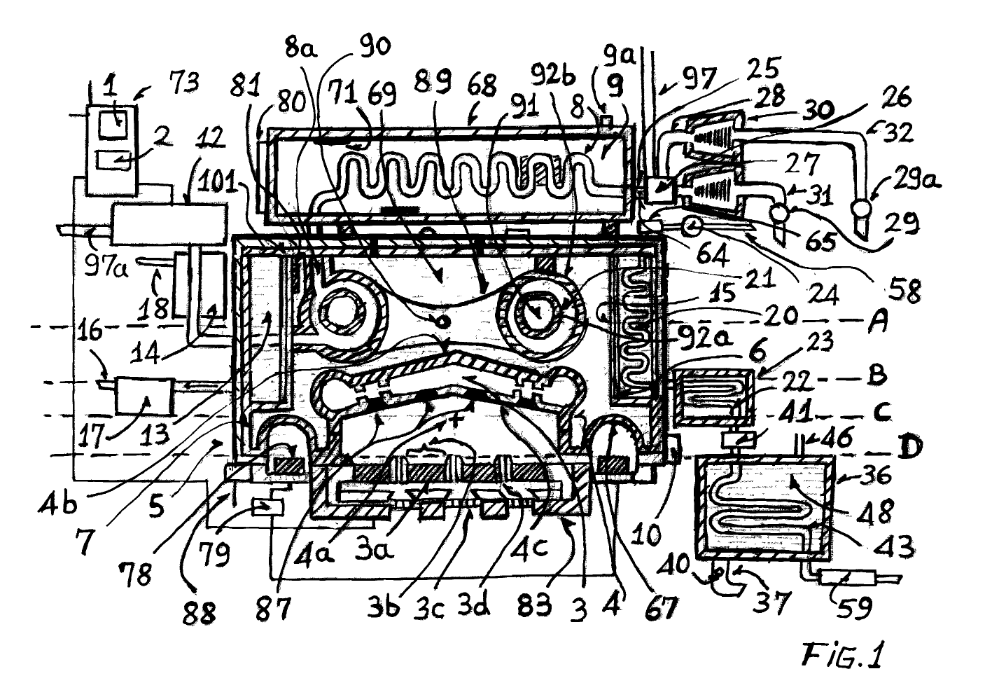

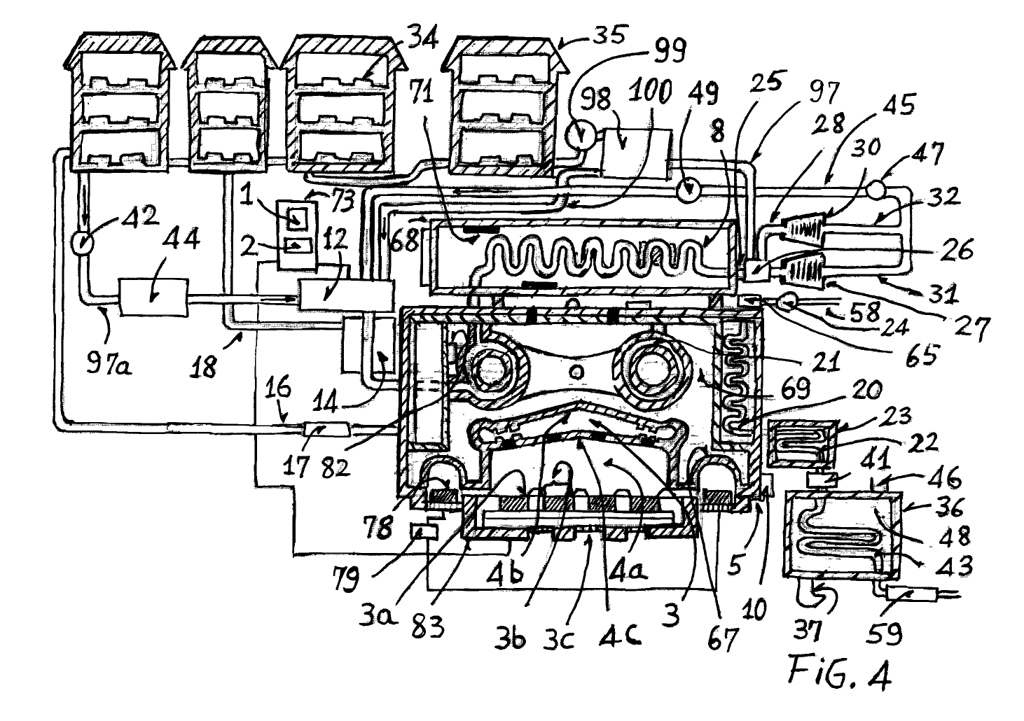

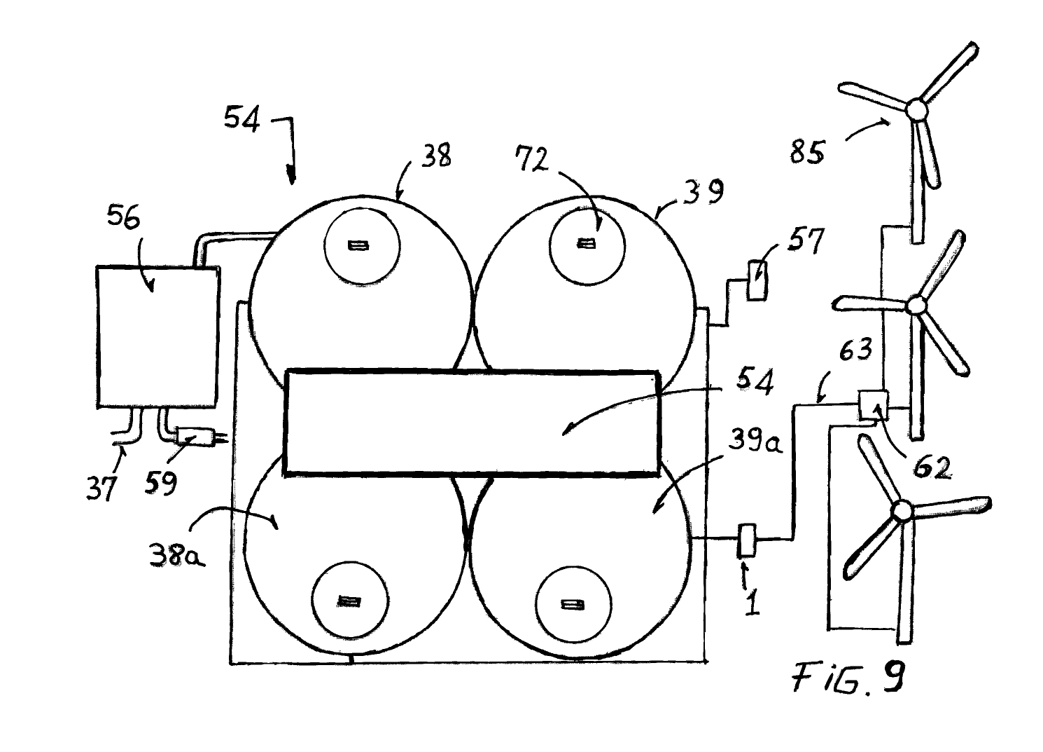

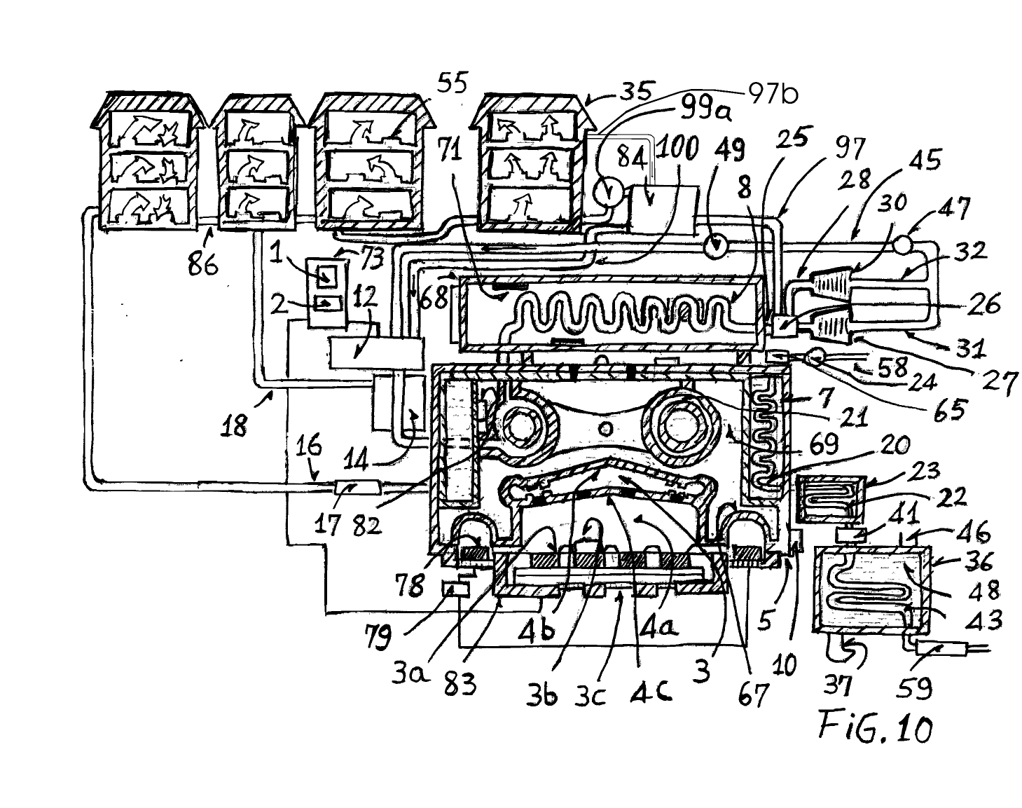

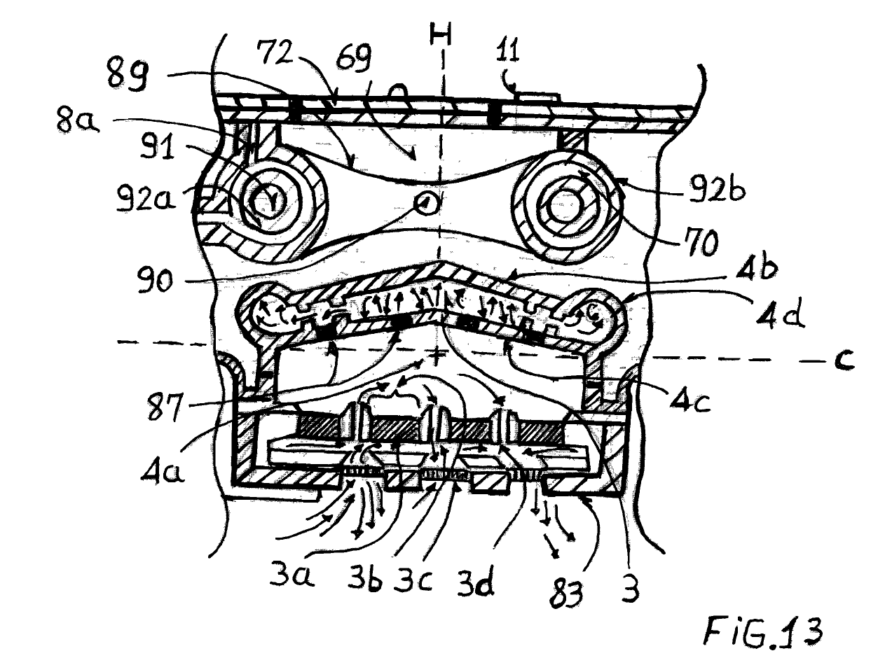

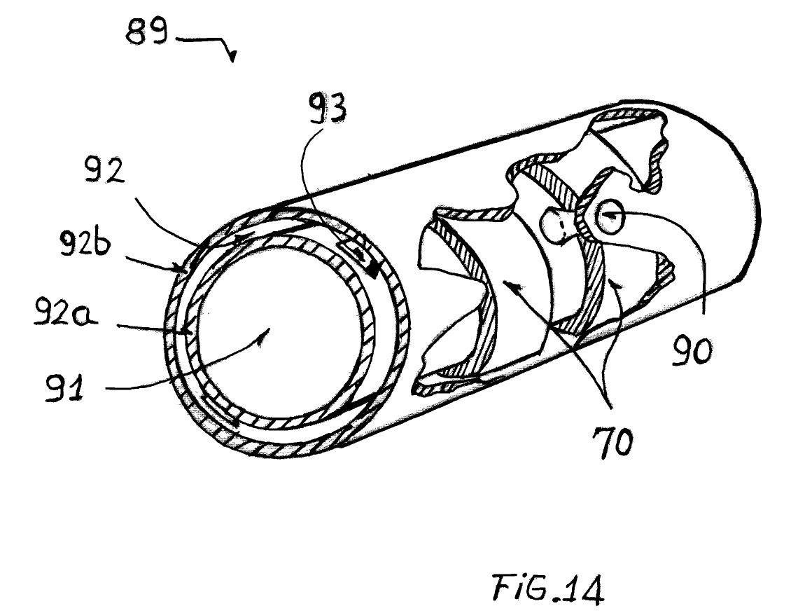

1. Operational electricity input from a renewable prime energy source such as wind and solar (preferred prime energy).
2. Operational electricity input from the utility grid (alternative prime energy).
3. Closed container 4 internal volume that closely approximates an ideal blackbody container 4 condition therein with lower surface 4c with an area of radiant energy absorption double surface container 4 that has a structurally strong atomic and molecular formation maximizing absorption.
3a. Infrared radiation emitter members, each positioned in its housing on the circular structure 84.
3b. Area corresponding to the surface area of each radiation emitter member 3a.
3c. Air flow grids for cooling emitter members 3a, from below infrared emitter members 3a.
3d. Air in and outflow channels through the circular structure 84 that houses infrared radiation emitter members 3a, which enable cooling of infrared emitters 3a and volume 4a from below.
4. Radiant energy absorption double surface container, preferably made of carbon-carbon composite or another composite with very high radiant energy absorption rate, and this container is one solid structure made of upper surface 4b and circular sections 4d, surfaces facing the molten salt TES volume 69, are coated with Ni3Al or another state of the art coating, the internal volume 3 is the internal volume of the container 4 which approximates a blackbody condition hence heat is absorbed by the surfaces 4b, 4d.
4a. Infrared radiation 74, enclosed radiation throughput volume.
4b. Upper surface of the double surface container 4.
4c. Lower surface of the double surface container 4.
4d. Container 4 circular sections between upper surface 4b and 4c, where the container 4 is a single structure and 4d are the circular corners on left and right sides in cross sectional view.
5. External insulation layer of the TES 69 that is moisture proof.
6. Internal semi-insulation layer facing the service hot water volume 13 and refrigerant gas coil heating oil volume 20.
7. TES molten salt tank volume 69 enclosure frame-wall, of which internal surface is coated with non-corrosive coating of Ni3Al or another state of the art coating, (if not made of concrete).
8. Working gas spiral pipe coated with PYROMARK trademark paint or another state of the art high absorption paint which gets infrared radiant energy within the cylindrical container 68.
8a. The vertical section of the working gas pipe 70 before it enters the cylindrical container 68, exiting the TES 69, which then becomes working gas spiral pipe 8 therein.
9. Air volume within cylindrical container 68.
9a. Air pressure release two-way air valve for the contracting/expanding air within unit 68.
10. TES 69 molten salt volume drainage valve.
11. TES 69 molten salt volume filling pipe.
12. Condensed returning working gas 50 and lower pressure steam post turbines re-entry pre-heater unit pre-steam generator unit, utilizing the feedback steam which gets utilized by steam turbines 30 and 27 first.
13. Service hot water tank volume-left side that is around ½ of the total cylinder surface area of the TES volume 69 enclosure 7 circumference (left).
14. Pre-heater unit for service hot water volume 13 input.
15. TES volume conduction material with desired level heat conduction properties-cylindrical external surface area 15 facing the semi-insulation layer 6 for service hot water and refrigerant gas coil heating oil volume 20, on enclosure frame-wall 7.
16. Service hot water circulation outgoing pipe (left side in drawings).
17. Service hot water temperature sensor and regulator unit-outgoing (left).
18. Service hot water tank-water supply entry pipe (left).
19. Refrigerant gas (freon-12 or di-chlorodifluoromethane type, which boils at −29.8 C).
20. Refrigerant gas coil heating oil volume that is around approximately ½ of the total cylindrical surface area of the TES volume steel enclosure circumference (right side).
21. Refrigerant gas heater spiral coil section within volume 20 (right side).
22. Refrigerant dissipation coils (right).
23. Refrigerant gas coils condenser (right).
24. Refrigerant gas second pump.
25. Working gas pipe exiting TES 69, pre turbine 27 and 30.
26. Steam power distribution valve on pipe 25, pre-turbines 27 and 30.
27. Steam turbine and generator, (primary mover, steam turbine 1).
28. Working gas pipe exiting steam power distribution valve 26, pre turbine 30.
29. and 29a. Post turbines steam pressure-temperature electronic sensors on pipes 31 and 32 (FIGS. 1, 2, 3 only).
30. Steam turbine and generator, (primary mover, steam turbine 2).
31. Working gas closed cycle central heating circulation pipe-past turbine 27.
32. Working gas closed cycle central heating circulation pipe-past turbine 30.
33. High pressure working gas-pre turbines.
34. Radiators (FIG. 4).
35. Residential and/or commercial buildings (FIGS. 4 and 10).
36. Central air conditioning chilled water tank unit located next to TES (right, FIG. 1).
37. Chilled water unit outgoing distribution pipe for central air conditioning.
38. Cogeneration TES unit 1 in the four units combined TES plant configuration (FIG. 9. reference numbers 39, 38a, 39a, all are about FIG. 9).
38a. Cogeneration TES unit 3 in the four modular units combined TES plant configuration.
39. Cogeneration TES unit 2 in the four modular units combined TES plant configuration.
39a. Cogeneration TES unit 4 in the four modular units combined TES plant configuration.
40. Chilled water output temperature sensor exiting chilled water volume 48 pipe 37 (FIG. 1).
41. Refrigerant gas 19—expansion valve (right).
42. Second pump for the returning condensed working gas 50 back to TES pipe section.
43. Chilled water unit closed cycle cooler coils in water chiller unit 36.
44. Second pump for regulating the flow rate of returning condensed working gas 50 back into the returning working gas 50 re-entry pre-heater pre-steam generator unit 12.
45. Working gas closed cycle circulation pipes 31 and 32 united as a single feedback steam pipe back into working gas pre-heater pre-steam generator unit 12.
46. Chilled water tank water supply pipe (right side).
47. Pressure sensor unit (FIGS. 4 and 10).
48. Chilled water unit internal chilled water volume (see FIG. 1).
49. Feedback working gas recycling pump (FIGS. 4 and 10).
50. Returning working gas—post central heating premises 35.
51. The modularly enlarged higher capacity working gas (not in drawings).
52. The modularly enlarged higher capacity working gas and total TES volume configuration, with two units combined (no drawing).
53. The modularly enlarged higher capacity working gas and total TES volume configuration of FIG. 9, with four units integrated.
54. Top view of the common higher capacity larger energy density increasing means cylindrical container, located on top in the middle of the modularly enlarged capacity four units higher capacity working gas and total TES volume (FIG. 9). configuration.
55. Forced air space heating outlet points—in residential and commercial premises 35 (FIG. 10).
56. The four modular integrated units TES configuration plant common chilled water unit located next to the TES, for central air conditioning (FIG. 9).
57. Utility grid electrical input connection control board to the four units configuration plant (FIG. 9 only).
58. Refrigerant return coil into the refrigerant gas coil heating oil volume.
59. Refrigerant pump.
60. First cooled water general distribution and return pump (not shown in drawings).
61. Second cooled water general distribution and return pump (not shows in drawings).
62. FIG. 9, wind turbine electrical energy input collector and transformer.
63. 100 percent renewable energy electrical energy cable connection (FIG. 9).
64. Working gas pipe 25 electronic steam pressure control sensor (only in FIG. 1).
65. Refrigerant gas compressor.
66. Container 4 temperature control electronic sensor (not shown in the drawings).
67. Concentric ring surface for backup infrared radiation below molten salt TES 69.
68. A cylindrical container-volume outside the TES 69 for the fast energy density increasing means of the working gas with the spiral pipe section 8 therein.
69. TES molten salt volume that contains the double surface circular pipe 89.
70. Working gas pipe section in flat and wide form which is within the double wall-surface circular pipe 89.
71. Infrared members within the cylindrical container-volume 68.
72. Pressure and heat transfer medium tight lockable lid that enables access into the molten salt TES volume 69 for repairs, after molten salt is emptied.
73. Working gas flow rate and pre-heater thermostat and temperature control electronic sensor-timer control board, integrated with control boards of 1 and 2.
74. Infrared radiation that is applied through the volumes 4a and 9.
75. Radiated temperature of the upper surfaces 4b and 4d of the container 4.
76. Molten salt volume 69 temperature prior to infrared radiation 74 input.
77. Wait periods of non-radiation between radiation periods, when heat continues to get conducted into TES 69.
78. Secondary backup radiation emitters below TES 69 for the concentric ring surface 67.
79. Independent circuit operational electricity input control board for the secondary-backup means infrared member for the concentric ring surface 67.
80. Air tight closure that enables access to energy density increasing means cylindrical container 68, which is accessible to only expert company personnel.
81. TES thermostatic sensor electronically connected to control boards; to integrated board 73 with 1, 2, and to sensor 66.
82. The separation wall of which TES facing surface area is 15, of the service hot water tank 13 and the refrigerant hot oil tank 20, where each are around one-half circumference of the cylindrical TES 69 side wall, for heat utilization from TES 69.
83. Circular structure holding infrared radiation emitter members 3a with air flow grid 3c for cooling.
84. Heat exchanger for hydronic coil to forced air heating-air handler of FIG. 10.
85. A group of wind turbines of the 100 percent renewable energy configuration (FIG. 9).
86. Central forced air distribution duct alternative to water based system (FIG. 10).
87. Radiant energy input openings of closed container 4, that enables inflow into volume 3 through bottom surface 4c of interface 4 that closely approximates a blackbody condition.
88. Static electricity discharge grounding line connection.
89. Double surface circular pipe within the TES 69, which contains the working gas pipe 70.
90. Small inlet channels between the walls of the double surface circular pipe 89 that let molten salt to enter the middle volume 91 of the circular pipe 89.
91. Molten salt containing middle-central volume of double surface circular pipe 89.
92. Double surface circular pipe 89, internal volume containing the flat and wide working gas pipe 70 which circulates therein.
92a. Inner wall of the double surface circular pipe 89.
92b. External wall of the double surface circular pipe 89.
93. Internal structural supports between the outer 92b and inner 92a walls of the double surface circular pipe 89 positioned as oppositely located pairs within volume 92, (FIG. 14).
94. Enclosure that makes infrared emitters 3a and radiation volume 4b, and the approximate ideal blackbody container 4 inaccessible to unauthorized people.
95, 95a. Closures of 94 which can be opened only by the expert company personnel.
96. Foundation upon which the system and the TES stands on.
97. Central heating distribution steam pipe connecting to steam to water heat exchanger, post steam power distribution valve 26, for water based central heating circulation, or to the heat exchanger for hydronic coil to forced air heating-air handler 84.
97a. Returning central heating distribution hot water pipe, post residential and/or commercial buildings.
97b. Returning central heating distribution forced air pipe returning to the heat exchanger 84 for hydronic coil to forced air heating-air handler, post residential and/or commercial buildings.
98. Steam to water heat exchanger for the central heating circulation.
99. Water based central heating water pump, post steam to water heat exchanger 98.
99a. Central heating distribution forced air pipe pump.
100. Post steam to water heat exchanger 98, or heat exchanger for hydronic coil to forced air heating-air handler 84 pipe that connects back to pre-heater pre-steam generator unit 12.
101. TES volume top side frame which gets mounted after the double surface circular pipe 89 gets assembled in first.

### DESCRIPTION OF EMBODIMENTS

This invention is based on the following principles and method combination:

1. An energy efficiency increasing means which utilizes lower installation cost, substantially smaller scale-capacity solar or wind energy installation operational energy input; where the increased energy efficiency differential of this means with at least 90 percent and the ability to store this high stability thermo-dynamic energy, is substantially greater than the energy generation efficiency that can be due to a large scale-capacity stand alone solar panels installation or a large stand alone wind farm installation. Because large scale wind farms and solar panels peak electrical energy generation capacities cannot be stored and have to be unloaded at un-economic rates, whereas with this system for both for wind and solar, almost all of the renewable energy surplus gets stored with high efficiency;

2. Industrial scale state of the art high quality infrared radiant energy emitters, of which the radiation is applied on a high technology carbon-carbon composite or metal alloy material with very high radiant energy absorption rate and which therefore is also a good emitter, applied on a container 4 that emits thermo-dynamic energy into the molten salt containing TES 69 located above it. The container 4 is to closely approximate an ideal blackbody condition, with the radiant energy absorption angled surfaces 4b and 4d. Wherein, surfaces 4b and 4d facing the TES 69 molten salt volume have a non-corrosive coating of Ni3Al or another state of the art coating. A secondary concentric ring area 67 is a distinct and separate surface area under the same TES 69 circular bottom platform for the backup means and a third separate infrared radiation 74 providing members 71 are within a cylindrical container 68, spiral pipe section 8 made of highly corrosion resistant stainless/lined steel pipe with a coating of PYROMARK paint or a higher quality state of the art high absorption paint, is for the fast energy intensity increasing means;

3. A strongly insulated total kinetic energy stable and high temperature TES 69 molten salt reservoir with an internal non-corrosive coating of Ni3Al type applied on ASTM-SA210 grade 1 or ASTM-SA213-T-11 type of steel. The above mentioned coatings are not imperative, a coating that acts as an anti-corrosion layer against molten salt at a continuous high temperature operation range of 500-550 degrees Centigrade can be applied. Operation of the Aircraft Reactor Experiment (ARE) during the 50s and the Molten Salt Reactor Experiment (MSRE) in the 60s have proven the compatibility of a fluoride fuel mixture with Ni-based container alloys at maximum operating temperature of 710 degrees Centigrade. Hence, Ni-based container alloys can be considered. Zn—Mg coated steel sheet is another means in the industry that could be considered for the TES 69 molten salt tank internal surfaces. Instead of steel or alloy, concrete would be a good choice for a lower cost molten salt TES 69 container tank and also to avoid corrosion. Within the TES 69, located is the double surface circular pipe 89 containing the flat and wide working gas pipe 70. The double surface circular pipe 89 enables the molten salt to enter the middle volume 91 of the steam generator pipe 89 through small inlet channels 90 but the flat and wide working gas pipe 70 is contained separately within the walls 92a, 92b in internal volume 92 of the double-wall double surface circular pipe 89 and is protected from the molten salt. Flat and wide working gas pipe 70 is circulated within volume 92 and wherein both flat side surfaces of pipe 70 face the double surface circular pipe 89 walls 92a and 92b; so thermo-dynamic energy gets conducted into the flat and wide working gas pipe 70 by solid to solid heat conduction and on both sides maximized area.

4. The TES 69 has a larger total mass as compared to the total working gas mass and depending on the engineering choices would contain of one of the following: A static oil volume of hydrocarbon or carbon-tetrachloride type fluid, but ideally purified high density molten salt that is highly stable for continuous high temperature operation with high average heat conductivity, contains a high specific heat capacity medium that enables first equation condition that is derived from the qualify facility (QF) status formula, which instead reads as:

Power output+½ Useful Thermal Output/Energy Input>>42.5 percent (in one year;) (1).

5. A method of periodically providing infrared radiation with lower energy input phase first and then repeating the same, where each one reduced energy input interval lasts longer than a full on radiation period, along with off intervals in between, hence having longer periods of lower operating temperature input ranges and lower, efficient energy consumption spread in time, once the system starts to operate at base load.

The heat transfer means is as follows:

a. The infrared radiation application 74 area-volume 4a is below the enclosed container 4, and wherein the enclosed container 4 closely approximates an ideal blackbody container 4 condition therein with bottom surface 4c and upper surface 4b facing the enclosed container 4 internal volume 3, and the periodic infrared radiant energy 74 results in emitting the absorbed thermo-dynamic energy by the blackbody container 4, preferably made of a structurally strong composite material with very high radiant energy absorption rate and high temperature endurance, of which external bottom surface of 4c is the surface subject to direct radiant energy, wherein the radiant energy absorption and emitting is also increased due to the slightly larger surface area because of an angled surface structure and double surface structure radiant energy absorption container 4, wherein the angular plane with an angle that is at least downward-negative 10 degrees as compared to zero degrees horizontal and extends from one higher midpoint at the center, therefore is conical in form, which is a mid point on the vertical, referenced as line H represented by a 90 degrees intermittent vertical line (as shown in FIG. 13). instead of being zero degrees horizontal, and is located on the central part of the bottom surface of cylindrical TES 69. That is, the bottom of TES 69 made up by the double surface radiant energy absorption ideal blackbody approximating container 4, which is slightly conic. Based on the basic heat transfer equation applied to a heat exchanger, second equation:

q=U A(Ta−Tb) (2);

Where q is the rate of transfer and U the overall transfer coefficient; A is the surface area for heat transfer and (Ta−Tb) the average temperature difference. The area A of thermo-dynamic energy emitting surface area total is thereby made larger by the double surface container 4 surface area at the center of the container 4 bottom of the cylindrical TES 69 that is in the form of a double surface container 4 with an angled surface and has an enclosed volume 3, hence the rate of thermo-dynamic energy transfer increases.

b. The fast energy density increasing section volume within the cylindrical container 68 is air.

c. The spiraling pipe section 8, located within the cylindrical container 68 for direct heat exchange by the fast energy density increasing means has high infrared radiation absorption rate coating of durable PYROMARK brand paint with high absorption rate of 95 percent, or a better state of the art coating, and is made of a material with a structurally strong atomic and molecular composition which maximizes radiant energy absorption—such as highly corrosion resistant stainless/lined steel, and the spiral section 8 is continuation of pipe 8a coming out of TES 69 vertically, and this section circulating working gas pipe 8 is in a spiral shape to increase the total radiant energy transfer area, wherein radiant energy is provided by infrared radiation 74, thereby the energy density of the steam-working gas 33 is increased efficiently and swiftly.

d. Within TES 69, is hot-service water tank volume 13 surrounding the center part of the TES, utilizing the TES 69 waste heat for indirect heat exchange, with an internal semi-insulation layer 6 that is around the molten salt volume is enclosure side wall 7, cylindrical wall external surface area 15 and faces the internal semi-insulation layer 6 that covers the TES 69 molten salt that is enclosed within the enclosure side wall 7, and water is stabilized at 75 degrees Centigrade in service hot water tank volume 13, and utilizes waste heat from the TES 69.

e. A service hot water temperature mixer-regulator unit 17 for outgoing service hot water, that avoids water temperatures above a pre-selected upper threshold range of about 60-70 degrees Centigrade, it is utilized for heated water output for shower, dish-washing, washing machine or other appliances.

f. Within TES 69, is air conditioner refrigerant 19 heating tank 20 for indirect heat exchange with internal refrigerant coil spiral 21 that runs within the oil tank 20, that contains an oil stabilized at a range of 70-80 degrees Centigrade, likewise surrounds the other ½ of the external surface area 15 of the molten salt TES 69 of the cylindrical enclosure side wall 7, and also utilizes the waste heat to enable substantially less compression time for the refrigerant 19 to function with heat input from the molten salt TES 69, by the internal semi-insulation layer 6. The balanced waste heat utilization is made possible by insulation layer 6.

The fast energy density increasing means high efficiency is enforced by the utilization of the electronic sensor controlled working gas 33 flow control board 73 and returning working gas 50 pre-heater unit 12 that increases the pre-TES 69 entry temperature of the returning working gas 50, and with the total-kinetic energy stabilization factor with a high stability temperature range within the TES 69, which is the main contributor in the stabilization of the temperature of the working gas 33, this combination results in about 70 percent of the working gas 33 volume per cycle to pass through the spiral pipes section 8 within the cylindrical container 68, that is within the fast energy density increasing means, to arrive into the spiral section 8 with at least 500 degrees Centigrade, wherein the flow is without fluctuation in temperature per cycle, and only about 30 percent of the total working gas 33 volume circulating within the spiral pipe section 8 per cycle to pass through with an average kinetic energy that arrives at about 350 degrees Centigrade to be swiftly raised to 500-550 degrees Centigrade. Said spiral pipe section 8 is located at the center of cylindrical container volume 68.

FIG. 1 is a cross sectional depiction of the entire system that is made of at least one unit with infrared radiation 74 application volume 4a and upper blackbody surface 4b and circular corner sections 4d of the container 4 located below the cylindrical TES 69.

The double surface circular pipe 89 is within the TES 69, and therein the flat-wide working gas pipe 70 is circulated. Small inlet channels 90 between the two walls 92a and 92b of the double surface circular pipe 89 let molten salt to enter into the middle volume 91 of the circular pipe 89, thereby both surfaces 92a and 92b are subject to heat transfer, and the flat and wide working gas pipe 70 is circulated within volume 92 (see FIG. 14). and is protected from direct contact with the molten salt. Also shown is the renewable energy electrical input and control box-panel 1—integrated in control board 73 and to secure backup operational energy, the system is also connected to electrical input from the utility grid that may be through a non-renewable energy input control box-2—also integrated into one control board 73 controlling energy input for the infrared radiation units 3a. All of the triple integrated system components and sections—as integrated and located around the TES 69, enclosure wall 7 depicted. Cross sections A, B, C and D horizontal reference intermittent lines are about drawings 5, 6, 7 and 8 respectively, indicated in FIG. 1, as the relative vertical positions and corresponding to top views in drawings 5, 6, 7 and 8. The vertical reference intermittent line H (shown only in FIG. 13) and horizontal reference intermittent lines C meet with 90 degrees and this is to indicate how the container 4 is at least negative 10 degrees angled. The concentric ring surface 67 below the TES 69 for the system backup means, secured by the infrared radiation 74 providing members 78 below the molten salt TES 69, are also shown. Working gas pipe section 70 exiting the TES 69 vertically as pipe section 8a, enters the fast energy increasing cylindrical container 68, and becomes the working gas spiral pipe 8 therein. The TES volume 69 top side frame 101 is assembled onto the TES 69 later to enable to mount the double surface circular working gas pipe 89 into the TES 69 first during manufacturing.

In the context of keeping the system as a trade secret or to avoid reverse engineering, the technical details and know-how of the main critical system features of at least; the circular structure 83 holding infrared radiation emitter members 3a with air inflow grids 3c along with air in and outflow channels 3d, which are for cooling the emitter members 3a and volume 4a, radiant energy inflow openings 87 of the approximate ideal blackbody container 4, bottom surface 4c of container 4 that closely approximates a blackbody condition therein, infrared radiation 74 application volume 4a, the container 4 which is made of double surfaces 4b and 4c and corner sections 4d, the cylindrical container 68 fast energy density increasing means, all of these sections are kept secret and are to be made accessible to only expert company maintenance personnel and made tamper proof and inaccessible to others.

With reference to FIG. 1 again, the cylindrical structure 83 holds at least a multitude of infrared radiation emitters 3a at its bottom section, which are located in a series, positions the infrared radiation emitter members 3a preferably of ceramic heater type with 90 percent or higher electrical energy to radiant energy conversion efficiency, in between housings 3b and where each infrared emitter member 3a emits radiation 74 through housings 3b into the radiation input through volume 4a, where each housing 3b corresponds in area to the surface area of each emitter member 3a, where emitters 3a are mounted on the cylindrical structure 83, wherein this approximate ideal blackbody container 4 internal volume 3 has below an angular lower surface 4c, also of the double surface container 4 with an angular plane of at least downward negative 10 degrees angle, and said container 4 walls have a structurally strong atomic and molecular composition that maximizes radiant energy absorption of at least 97 percent and emits thermo-dynamic energy into the TES 69, through the blackbody container 4 upper surface 4b and circular corners 4d. The lower blackbody surface 4c of the double surface container 4 has high temperature durability, the emitters 3a are directed to the lower surface 4c of the blackbody container 4, thereby the infrared radiation 74 within the range of 300-650 degrees Centigrade. provides periodically radiant energy into the container 4, and surfaces 4b and 4d transfer heat into the molten salt TES 69 spread in time efficiently. The first embodiment TES 69 highest temperature is 550 degrees Centigrade. Static electricity grounding line 88 discharges static.

Referring to FIG. 1 again, the molten salt volume TES 69 is a highly stable medium in terms of the temperature range-stability, with high total kinetic energy therein, which in turn heats circulating working gas 33 within molten salt TES 69, in the flat and wide working gas pipe 70 which is within the circular pipe 89, which facilitates a working gas 33 that reaches a high temperature even before it enters the fast energy density increasing means cylindrical container 68, of which the closure 80 can be opened only by expert company personnel. The temperature stability of a minimum of 350 degrees Centigrade is secured and working gas 50 returns via pipe 97a back first into pre-steam generator unit 12 to become steam again and then gets into the pipe 70. The spiral pipe section 8 with infrared radiation absorbing coating and the working gas 33 proceed to circulate therein, which in a topping cycle method provides the high pressure pre-turbine steam 33 with about 1500 psig that is first used to generate power through steam turbines 27 and 30, and then heat the residential and/or commercial buildings 35 that circulates through the radiators 34.

Post turbine pipes 31 and 32: Enables working gas-steam 33 post turbines 27 and 30 to proceed for feedback; to the closed cycle feedback steam pipe 45 and back into working gas pre-heater pre-steam generator unit 12. The returning working gas 50 closed cycle central heating circulation returns through pipe 97a at a range of 40-65 degrees Centigrade, pre-heater unit 12 is for increasing the temperature of returning lower temperature working gas 50 post central heating, unit 12 which is a heat exchanger unit generating pre-steam before it enters the TES 69, of which the feedback steam also re-enters TES 69, to turn the condensate returning working gas 50 into steam again and the condensed hot water at about 60 degrees Centigrade, swiftly becomes steam 33 at least at 270 degrees Centigrade prior entering the circular pipe 89 within the TES 69, so that it can reach thermal equilibrium with the TES 69 very quickly and energy efficiently, that is within the molten salt TES 69 circular pipe 89 flat and wide working gas pipe section 70, and then goes through spiral section 8 within energy density increasing cylindrical container 68.

The return condensed working gas 50 return pipe 97a leads into the TES 69, returning circulated working gas 50 after being pumped by pumps 42 and 44 (see FIG. 4). of which the pumping speeds are fully adjustable and run on a slower flow mode in coordination to assist working gas to reach desired temperature within the TES 69, for the fresh working gas 33 to heat up to superheated steam 33 at 550 degrees Centigrade within the flat and wide working gas pipe 70. For the forced air system, the returning closed cycle pipe 97b re-enters the heat exchanger for hydronic coil to forced air heating-air handler 84, instead.

With reference to FIG. 1 again, shown is also the service hot-water outgoing pipe line 16 of service hot-water heat transfer and thermal equilibrium tank 13 that is located around the other ½ cylindrical external surface area 15 of the TES 69, that is covered with the semi-insulation layer 6.

Service hot-water, water input goes through the pre-heater unit 14. Also shown is air conditioner refrigerant gas coils 21 combined with an air conditioner and chilled-water unit 36 to provide a central air conditioning.

Air conditioner refrigerant heating coil 21 that runs within volume 20 is compressed by refrigerant gas compressor 65 and also heated by the waste heat from the enclosure wall 7 and semi-insulation layer 6 that is around the molten salt TES 69 cylindrical container wall 7.

The refrigerant 19 is heated to about 70 degrees Centigrade and its temperature and pressure increases by thermal input and compression combination. Pump units 24 and 59 are used to pump the refrigerant 19. The heat dissipation coils 22 allow refrigerant 19 to dissipate its' heat. As it cools, refrigerant 19 condenses into liquid form and goes through an expansion valve 41; the expansion valve 41 enables a low pressure evaporated and cold refrigerant 19 to proceed to the central air conditioning chilled-water unit 36, wherein it cools water to 4.4 and 7.2 degrees Centigrade. This chilled water is then piped out with pipes 37 through the buildings 35.

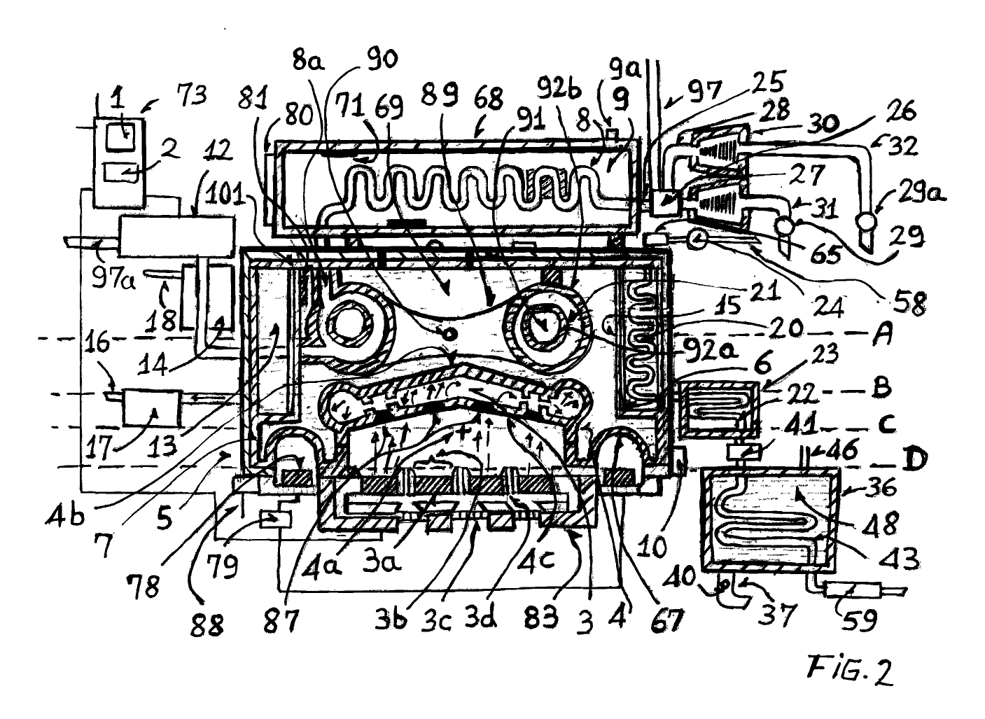

With reference to FIG. 2 is a cross-sectional view of the system as depicted when infrared radiation 74 input is provided through the radiation input volume 4a, onto the surface 4c and the surface 4c has at least two or more radiant energy 74 inflow openings 87. Furthermore, radiated surface 4c also conducts heat through the container 4 circular corner sections 4d and the radiant energy in the enclosed container volume 3 is absorbed by interfaces 4b, 4c and 4d, incident energy absorbed is shown as arrows within volume 3, radiation input is shown as straight arrows with small gaps within the radiation throughput volume 4a.

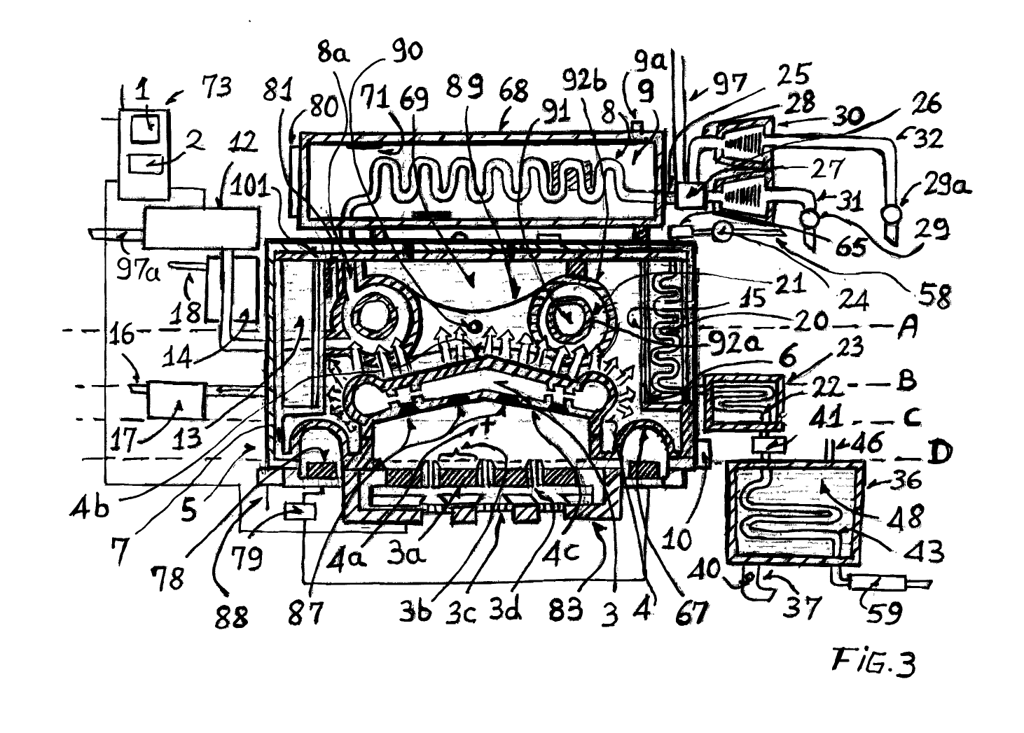

With reference to FIG. 3 depicted in cross sectional view, depicting how thermo-dynamic energy is emitted into the TES 69 through the container 4, and which has high radiant energy absorption rate and that maximizes thermo-dynamic energy emitting and preferably is made of a structurally strong material that has an atomic and molecular composition that maximizes absorption and is a double surface blackbody container 4 with an internal volume 3, depicted is emitting with small arrows coming out of upper blackbody surfaces 4b and 4d of container 4, as the upper surface 4b of container 4 emits energy into the TES 69 molten salt.

A strong insulation layer 5 insulates the TES 69, of one internal semi-insulation layer 6 within tanks 13 and 20 and one overall TES 69 insulator layer 5 of strong insulator.

The net work W done by the working gas can be approximated by the following third formula:

(Basis the internal energy; U) U2−U1=Delta U=Q−W. (Q+Energy added, W=Work) U2−U1=U=−W (3);

(TES 69 heat is replenished regularly and keeps a highly stable total kinetic energy).

With reference to FIG. 4, when the working gas 33 attains thermal equilibrium and becomes superheated steam 33 at least at 550 degrees Centigrade, this working gas 33 is distributed through the insulated output pipe 25. First, in topping cycle with high pressure through steam turbine 27 and 30 then with reduced steam temperature and lower pressure through the past turbine closed cycle steam feedback pipe 45 back to pre-heater unit pre-steam generator unit 12 and then into pipe 89 within the TES 69.

The returning working gas 50 returns to TES molten salt volume 69 condensed and at a lower pressure after having been circulated through all radiators 34, first re-enters the pre-heater unit 12, where the working gas 50 re-entry temperature is increased to pre-steam before it re-enters the TES 69, through the return pipe 97a to the section within molten salt TES 69 to reach thermal equilibrium in the circular pipe 89 that contains the flat and wide working gas pipe 70, again. Also seen is the water based steam to water heat exchanger 98, which gets steam heat input by the central heating steam provider pipe 97, the water based central heating pump 99 pumps hot water to the residential and/or commercial buildings 35, with hot water radiators 34. Pipe 100 takes exiting lower temperature steam from steam to water heat exchanger 98, and enters into the pre-heater pre-steam generator unit 12.

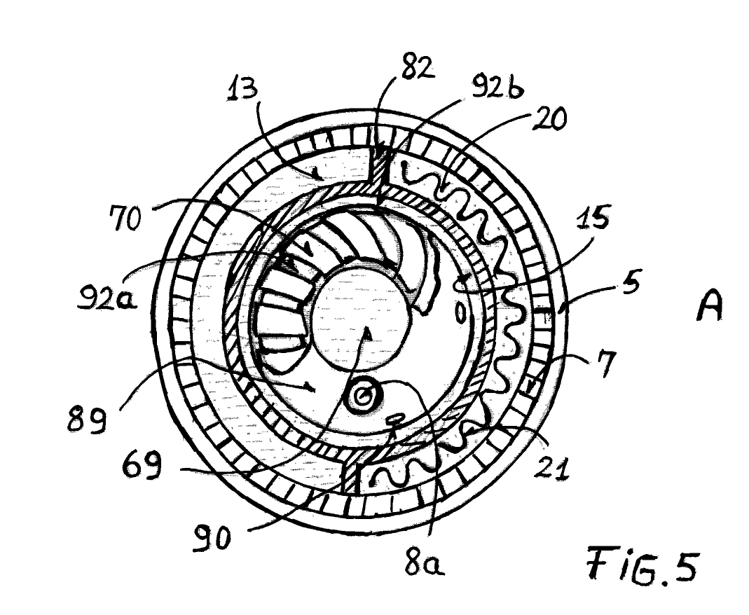

With reference to FIG. 5, it is a top plan view with top closure-frame 101 completely removed of one TES 69 unit, and the fast energy density increasing means cylindrical container 68 not shown, which is viewed from top showing the molten salt TES 69 volume that contains the double surface circular pipe 89, with one half hatched view of the top outer wall of the circular pipe 89, hatched on the upper side of the drawing, to show the flat and wide working gas pipe section 70 circulating around the molten salt containing middle volume 91 therein (91 not visible in this drawing), both made of highly corrosion resistant stainless/lined steel.

The TES 69 internal containers for service hot water tank 13 and the refrigerant gas coil heating oil volume 20 have separation wall 82 and is connected to the external wall 7, thereby separates service hot water volume 13 from refrigerant gas coil heating oil volume 20.

The service hot water tank 13 on the left side, that covers one-half the circumference of the TES 69, the other one-half of the circumference of the TES 69 is covered by refrigerant gas heating oil volume tank 20 (right) that contains refrigerant coils 21, double surface circular pipe 89 and flat and wide working gas pipe 70 is depicted along cross section A.

Working gas pipe section 70 exits the TES 69 vertically as pipe section 8a, enters the fast energy increasing cylindrical container 68, and becomes the working gas spiral pipe 8 therein—seen here as top plan view.

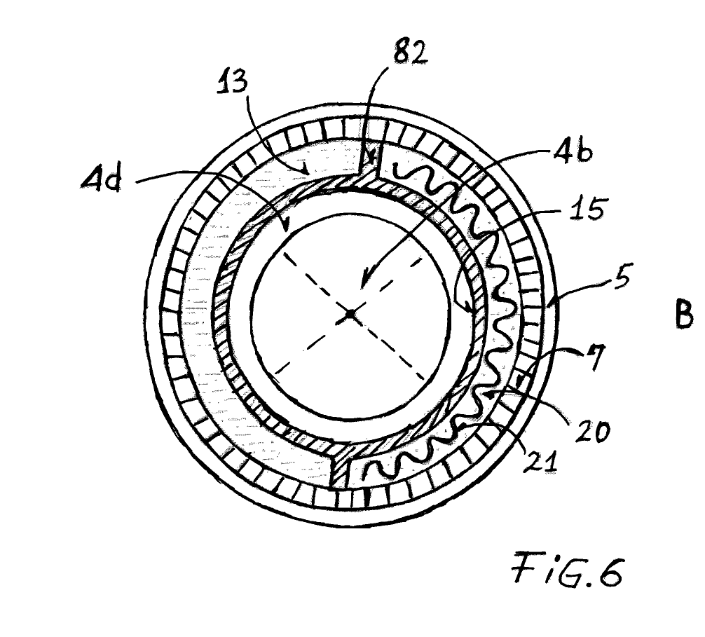

With reference to FIG. 6 it is a top plan view with top closure-frame completely removed of one TES 69 unit and the fast energy density increasing means container 68 not shown, which is viewed from top showing the surface top areas of surface 4b and circular corner section 4d along cross section B, below the molten salt TES 69 volume. Also are seen from top the service hot water tank 13 on the left side that covers one-half the circumference of the TES 69 and the other one-half of the circumference of the TES 69 is covered by the refrigerant heating oil volume tank 20 on the right that contains the refrigerant coils 21.

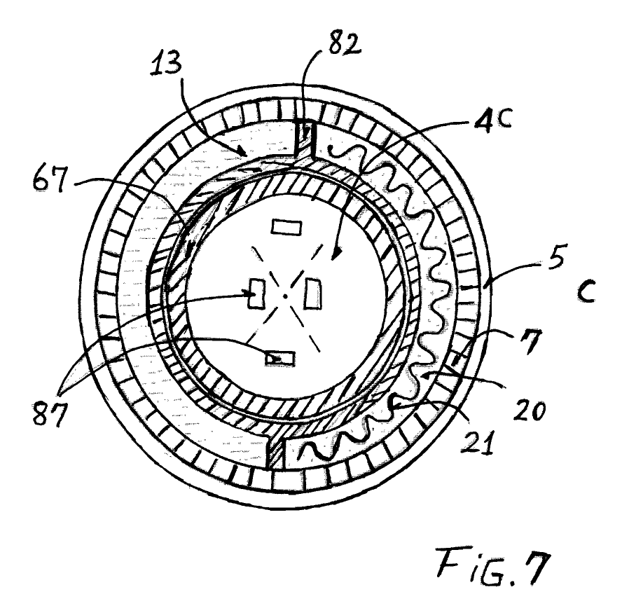

With reference to FIG. 7, it is a top plan view with top closure-frame completely removed of one TES 69 unit and the fast energy density increasing means container 68 not shown, which is viewed from top showing the backup concentric ring surface area 67 along cross section C, which receives radiation from a set of circularly positioned secondary backup infrared radiation emitters 78. Also are seen from top, the lower surface 4c which is subject to periodic infrared radiation with at least two or more openings 87. Also seen is service hot water tank 13 on the left side that covers one-half the circumference of the TES 69 and the other one-half of the circumference of the TES 69 is covered by the refrigerant heating oil volume tank 20 on the right that contains the refrigerant coils 21.

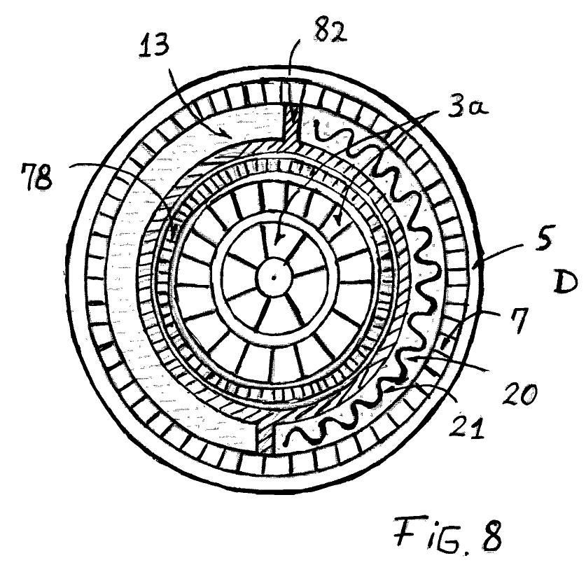

With reference to FIG. 8, it is a top plan view with top closure-frame completely removed of one TES 69 unit and the fast energy density increasing means container 68 not shown, which is viewed from top showing the circular secondary backup infrared radiation emitters 78, that is around the main means of the infrared radiation 74 emitter members 3a, which are at the center, are shown along cross section D with two series of emitters 3a one encircling the one in the middle.

Also are seen from top the service hot water tank 13 on the left side that covers one-half the circumference of the TES 69 and the other one-half of the circumference of the TES 69 is covered by the refrigerant heating oil volume tank 20 on the right that contains the refrigerant coils 21.

With reference to FIG. 9, shows in top plan view four TES 69 units combination as the modularly enlarged capacity system 54 as a whole, with only one larger fast energy density increasing means cylindrical container 68, each TES 69 unit is depicted as 38, 39, 38a, 39a, hence the four units combined enables to modularly increase the system capacity.

FIG. 9 also depicts the 100 percent renewable prime energy configuration, where operational energy is provided from existing wind farms or with a relatively low total cost-small number of new wind turbines 85 illustrated as being the origin source sufficient to provide operational input energy. The transmission and distribution system is shared by all four TES 69 units, hence it becomes more efficient.

The common cold water chiller unit 56, for the central air conditioning is also depicted; the chilled water output pipe 37 is for central air conditioning. The system can be a relatively compact, a 300 kW capacity system or relatively compact, relative to a higher output capacity, a modularly integrated higher capacity system with the integration of two, four, six, eight, and more modular and larger-higher capacity TES 69 units. Alternatively, as one high capacity TES 69 unit, the integrated system has higher capacity working gas 51, (single large TES not depicted) increasing overall system output capacity to about 15 MW capacity for small power plant type of capacity output. For example, one TES 69 unit has 300 kW capacity, when the TES 69 volume is enlarged the capacity of one TES 69 unit becomes 1 MW and when 15 units of these enlarged capacity TES 69 units are integrated at one site, it becomes a 15 MW plant. Any capacity between 300 kW and 15 MW is possible.

With reference to FIG. 10, it is a cross sectional view of the alternative central forced air distribution duct 86, heat exchanger for hydronic coil to forced air heating-air handler 84 if forced air is chosen over water based radiators 34 system.

With reference to FIG. 11, is a top view of the TES 69 top section with cylindrical fast energy increasing means container 68 located above the TES 69, showing the alternative viewing direction depicted in the next drawing FIG. 13, towards the direction along 107-107.

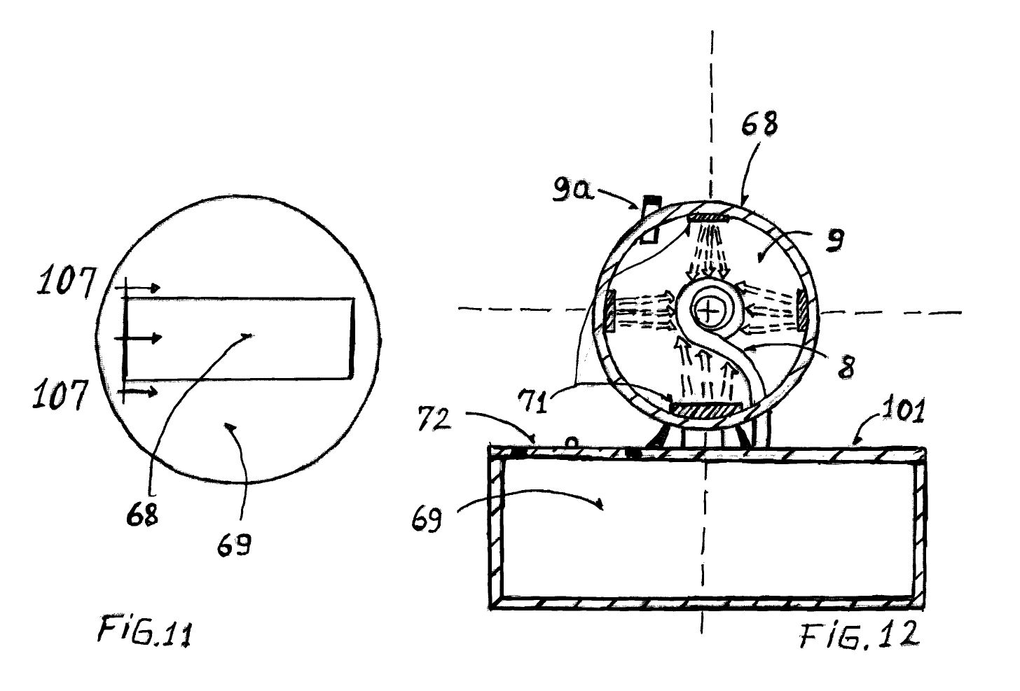

With reference to FIG. 12, it is the sectional view of the cylindrical container 68 volume, along the line 107-107. It shows the working gas infrared radiation 74 absorbing paint coated spiral pipe section 8 that is located at the center of the cylindrical container 68, receiving radiation 74 and where the fast energy density gets increased by at least four infrared radiation emitters 71 positioned to provide radiation from four different directions, with 90 degrees differential in radiation path between each emitter, located on and emitting from the inner surface walls of the cylindrical container 68 facing the center of the cylindrical container 68. Each emitter 71 is depicted as further away from the viewer, the nearest one being the one at the bottom. Infrared radiation 74 indicated as triple arrows with intermittent lines from each emitter 71, directed to spiral pipe 8.

With reference to FIG. 13, it is the larger, focused depiction of the container 4 that closely approximates a blackbody condition surfaces 4b, 4c and 4d. The energy density increasing means cylinder container 68 on top is not depicted. The circular structure 83 houses the infrared radiation emitter members 3a and enables air inflow through grids 3c below and it has air inflow channels 3d to cool radiation emitter members 3a and the radiation 74 throughput volume 4a. Air in and outflow into volume 4a is shown with arrows. Radiant energy 74 entering volume 3 through openings 87 is absorbed by the interior walls-surfaces 4c, 4b and 4d of the closed container 4. Also seen is the double surface circular pipe 89 in cross sectional view within the TES 69, containing the flat and wide working gas pipe 70. Arrows in the internal volume 3 indicate the radiant energy that gets absorbed by surfaces 4c, 4b, and 4d.

With reference to FIG. 14, it is the front cross sectional and three dimensional perspective partially hatched view combination of the double surface circular pipe 89 showing how the small inlet channels 90 reach the middle molten salt volume 91, and the relative location of the flat and wide working gas pipe 70 circulating within volume 92 of the double surface circular pipe 89. Within volume 92 are also the internal structural supports 93, between the external 92b and inner 92a walls of the circular pipe 89.

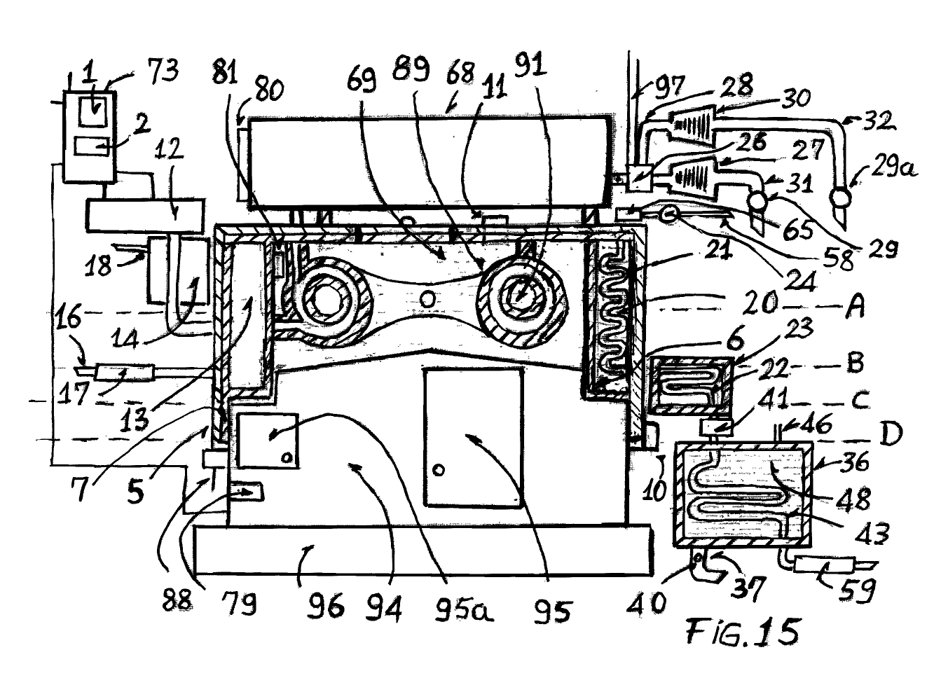

With reference to FIG. 15, it is the cross sectional view of how infrared radiation emitter members 3a, the secondary backup radiation emitters 78 and the infrared radiation application volume 4a are made tamper proof and inaccessible to unauthorized people by containing these in an enclosure 94, which has tamper proof closures of 94 and 95 and the fast energy density increasing means cylindrical container 68 also has a tamper proof closure 80 and is made inaccessible to unauthorized people.

The system would be monitored and controlled by a direct digital control (DDC) computer. Operation parameters are based on volumes, pressure, temperature and working gas flow controls.

Monitoring Devices

For the various volumes and components, voltage regulators for the generator turbines, power output and mechanic switches and electronic controls have to be used. System operation conditions are based on two main phases: 1. Before base load: This is before reaching the temperature range of 400-500 degrees Centigrade within the TES molten salt volume 69. (500-600 degrees Centigrade, 2nd embodiment). 2. Post base load: After the temperature of the TES molten salt volume 69 reaches a range of 400-500 degrees Centigrade stabilized, sustained. (500-600 degrees Centigrade 2nd embodiment).

The data coming from these sensors would be monitored continuously by the computer and direct digital control (DDC). Before the base load and peak load operation conditions are reached, the computer would do the initialization with the following initialization fourth algorithm, based on the pre-radiation temperature of the upper surface 4b of the double surface container 4 that closely approximates an ideal blackbody radiator and infrared radiation temperature readouts.

The radiated state 75 of the upper surface 4b of the blackbody container 4 results in increasing the thermo-dynamic energy of the TES 69 and the non-radiation state wait periods 77; where radiation frequencies can be adjusted and all wait periods 77 are in terms of post-radiation 74 applied state upper surface 4b, container 4 temperature: (Power on-Initialization):

Do (4);
If (infrared emitters operate initially on reduced energy input phase from renewable source 1 and have completed reduced energy input phase).

Then; raise operational energy input to normal radiation level;

Else if (source is to be utility 2; get input energy from the utility grid 2, then; raise operational energy input to radiation level);
Frequency of radiation=Get frequency pre-radiation temperature 74 (To) of TES 69;

Activate infrared radiation Start (to);
Stop infrared radiation when sensor 82 reads; (TES 69 temperature=500 C) End (t1);
(At the end of every radiated state 75; apply to+t1 non-radiation wait state 77);

Wait (frequency to+t1=radiated wait state 77);

While do

If (radiated temperature 75 of surfaces 4c or 4b of container 4<350 C);
Frequency of radiation=A; (set to long period timer and high frequency), or;
Else if (working gas 33 temperature pre-container 68 volume spiral section 8 entry<350 C);
Activate infrared radiation in container 68 volume until 40 percent working gas 33=550 C;

Else if (radiated temperature 75 of surfaces 4c or 4b of the container 4<500 C);
Frequency of radiation=C; (set to middle duration and middle frequency.) or;

Else if (TES 69 temperature<300 C for a period exceeding preset time limit);
Activate secondary infrared emitters 78 on TES 69 bottom concentric ring 67;

Else if (radiated temperature 75 of surfaces 4c, 4b of container 4<550 C);
Frequency of radiation=E (set to base load; optimal duration low frequency) and;
Activation frequency of infrared emitters 71 in cylindrical volume 68 for working gas 33=Set to minimum frequency;
(Only activated for 30 percent, and for 100 percent if at peak load, of the working gas 33 in spiral section<or equal to 350 C);
(For second embodiment: If radiated temperature 75 of surface 4c of container 4=600 C);
Frequency of radiation=E; (set to base load; low frequency). (Repeat cycle).

The initialization and then gradually reaching the desired base load temperature of the TES 69 as a function of the radiated state 75 of upper surface 4b of container 4 stands at a temperature range of 350-550 degrees Centigrade, heated by radiation 75 temperature range of 450-650 degrees Centigrade and therefore the TES molten salt volume 69 long term temperature range of 400-550 degrees Centigrade gets stabilized due to specified time interval repeated radiant energy supply that would be provided by the infrared radiation members 3a.

The maximum 550 degrees Centigrade of the TES and maximum 550 degrees Centigrade of surface of 4b periodically becomes equal for certain periods, hence this enables radiation 74, a long term balanced pattern of energy input, which is for short intervals and with high energy efficiency.

Every time the two are equated; which can remain so for certain periods or are within the range of 500-550 degrees Centigrade for example, there is no need for radiation 74 input. Therefore, fast thermo-dynamic energy flow occurs when the average of the TES 69 is 400 degrees Centigrade or equal to 500 degrees Centigrade and surface 4b is 500-650 degrees Centigrade, 650 degrees Centigrade being a short term maximum, and periodic radiation 74 temperature is 650 degrees Centigrade for example. Wherein, this contributes thermo-dynamic energy input into at least one TES volume 69 by the double surface container 4.

A lower range radiant energy within 400-500 degrees Centigrade with shorter duration radiation in the radiation closed container 4a is to be provided along with strong insulation of the TES 69, once the TES 69 temperature gets stabilized at about 500 degrees Centigrade; thereby less energy is needed to keep TES 69 temperature stable.

Purified molten salt or combined molten salt or oil; both have a higher average density (kg/m), higher heat capacity (cal/C), higher average heat conductivity (W/m K), higher average heat capacity (kJ/kg K) and higher volume specific heat capacity (kWh/m) values than water, if once-one of these materials reach a high threshold temperature. Hence, one of these choices would establish a thermo-dynamic energy storage stability volume, once the threshold temperature is stabilized.

What is meant by “thermo-dynamic stability” as related to specific heat capacity defined by the following fifth formula:

c=Q/Delta T/m (5);

where Q is expressed in calories, it is the fact that it would take considerably less energy for example, the (kcal) of heat-once a threshold of high temperature range gets stabilized, to raise or keep the temperature at a certain range of a said fluid mentioned above, while having minimized losses by strong insulation, as compared to heat input needed to raise the temperature by one Celsius degrees of another reservoir, of another element of equal mass.

After base load conditions are reached, the computer would start operational and monitoring functions with the sixth algorithm that is based on the TES 69 molten salt temperature instead of the pre-radiation molten salt TES 69, and the radiated wait periods 78 and volume temperature readings thereafter, as follows:

While not stopped (6);
Temperature=TES (69) Temperature-T1 (to);
Frequency of radiation=Get frequency (TES 69 Temperature);

Activate infrared radiation (74) Start (to);

Stop infrared radiation (74) End (t1);

Wait (frequency to+t1=First period radiated state 75);

Temperature=TES (69) Temperature-T2 (t1);
Frequency of radiation=Get frequency (TES 69 Temperature);

Repeat Cycle for next radiation:
Activate infrared radiation (74) Start (t1);
Stop infrared radiation (74) End (t2);
Wait (frequency to+t1=Second period radiated state 75);
Power Generation=Get Power Output (e);
If (Power Output>Optimal (e));
Frequency of radiation=E; (set to base load; low frequency).

If (Power Output<Optimal (e));
Frequency of radiation=C; (set to middle duration, middle frequency);

If (Heat generation for central heating<Optimal; Temperature T);
Frequency of radiation=C; (set to middle duration, middle frequency);

Else if (TES Temperature>500 degrees Centigrade;
(Second embodiment: Else if TES Temperature>600 C);
Set frequency of radiation=G; (Overheated; Set to low frequency

until TES temperature=500 degrees Centigrade); or (optional);

Set frequency=I; (System overheats—second option: Full stop).

This system offers very important advantages as compared to combustion systems for example. The invention enables a fully secure control method against overheating accidents, as indicated in the last line of above algorithm. There is no risk of a disaster, no waste products; no exhaust heat loss.

Central Chilled-Water Air Conditioner Unit

The molten salt in the TES 69 has to be kept at a temperature range of 400-550 degrees Centigrade. Sodium freezes at 208 F (97.68 C, and remains liquid at 288 degrees Centigrade). Therefore, the TES volume 69 temperature must never decline below 350 degrees Centigrade. The hot TES volume 69 central air conditioner refrigerant 19 hot spiral coil 21 to be heated to 70 degrees Centigrade within the waste heat utilizing oil volume 20, which surrounds ½ of the external cylindrical surface area 15 of the TES 69.

In order to increase the pressure of the refrigerant 19, mostly the waste heat of the TES 69 is utilized to increase temperature and thereby also the pressure of refrigerant gas 19 to 70 degrees Centigrade. to enable much shorter total compressor time, or absorption cooling is utilized.

Demand for service hot water is about the same in summer; energy is needed for service hot-water tank 13 throughout all seasons. Utilization of the waste heat from the TES volume 69 for both central air conditioning chilled-water unit 36 and to provide heat for the service hot-water tank 13, and provide power with the steam turbines 27 and 30, or of more units of turbines based on capacity, this combination makes the system to be utilized all year long efficiently. In summer; all of the working gas-steam 33 is available for power generation.

Return on investment would occur sooner, electricity can be sold on a contract basis to users outside of host facility, while satisfying air conditioning needs.

Investment Feasibility

Due to the feature of the complete independence from all types of combustion-fossil fuels and the ability to utilize both renewable and utility power as operational energy input, the system is very efficient and flexible. Thereby, the long term operational energy input cost becomes negligible. The organizer company would have the option to have a modular design and production method where the components can be made by one or several different expert companies with established economies of scale and these could be modularly assembled. The organizing company can have a relatively low capital intensive investment. Return on investment can be realized in a substantially shorter time, as the system could become efficiently operational with optimal system capacity utilization conditions much sooner as compared to comparable capacity combustion plants and due to high profit margins on system sales or on high profit rate leases. The system is suitable to provide onsite-decentralized customized solutions, enables diversification and provides high modularity and flexibility. Since there is no central heating demand in summer; power generation level would be maximized. This enhances faster return on investment, as electricity can be sold on contract basis to outside of host facility, while satisfying even peak load air conditioning.

In compliance with the statute, the invention described herein has been described in language more or less specific as to structural features. It should be understood, however, that the invention is not limited to the specific features shown, since the means and construction shown is comprised only of the preferred embodiments for putting the invention into effect. The invention is therefore claimed in any of its forms or modifications, and for the more than two combined system TES units, within the legitimate and valid scope of the amended claims, to be appropriately interpreted in accordance with the doctrine of equivalents.

The device and the methods mentioned heretofore have novel features resulting in a new device, method for high efficiency, and a second embodiment system of which the capacity can be increased modularly, that are not anticipated, rendered obvious, suggested, implied by prior art systems, alone or in any combination thereof.

What is claimed is:

1. An energy conversion and generation system which in the long run has the capability to leverage the operational energy input provided by the small installation-capacity wind and solar renewable prime energy, or from the utility grid, by activating with this electrical input the main infrared radiation means, which only after a very short initial power load period of about one week, results in an efficient system capacity utilization and in a high stability and high efficiency total kinetic energy thermal energy storage (hereinafter denoted as TES,) that has high efficiency utilization characteristics which enables to spread energy utilization in time and provides optimization based on demand fluctuations, and the high efficiency of at least 90 percent at normal-base load mode operation on renewable prime energy source input of the system is made possible by the synergy and mutual enhancement of the efficiency of the main radiation means and closely approximated ideal blackbody absorber-radiator, the (TES) and the energy density increasing means combination, along with the regulated energy input method, consisting of:
a) a main high efficiency thermo-dynamic energy generation capability means, made of a set of infrared radiation energy emitters activated by electrical operational energy input for relatively short intervals of radiation, being spread over a long time; hence in the long run stable and efficient radiant energy is provided, wherein the main means is capable to be the single radiant energy input for the system, and the main radiant energy generation means temperature is adjustable within minimum, intermediate and maximum intensities and as well as short, intermediate and long term timing interval ranges, and;
b) as part of the main radiant energy means, at least one closed container that acts as an approximate ideal blackbody radiator, wherein the radiant energy entering the openings on the lower surface of the container is absorbed by the interior walls of the closed container therein, made of a composite or a metal alloy that absorbs at least 97 percent of incident energy and then emits thermo-dynamic energy in time with high efficiency into the (TES,) and;
c) at least one hot (TES) cylindrical container made of concrete for a lower cost molten salt (TES) container tank and also to avoid corrosion, or made of steel containing high density molten salt, wherein this high density enables a compact and thermo-dynamically stable mass (TES,) which has high specific heat capacity; and contains a circular-steam generator pipe within, that protects the working gas pipe within from molten salt,
d) the total (TES) high density molten salt mass is greater by mass than the total working gas mass by a certain proportion to maximize thermo-dynamic stability of the (TES,) wherein this proportionality of the (TES) mass to smaller working gas mass enables a substantially shorter power load period and keeps the long term stability of the total kinetic energy of the (TES,) by providing an optimal volume thermo-dynamic energy reservoir and enables the utilization of this accumulated energy to be spread in time, and;
e) as part of the fast energy density increasing feature, at least one external cylindrical container located above the (TES) that has an internal surface wall coating which is infrared radiation reflective and which directs the minor reflected part of the infrared radiation back onto the spiral pipe located in the middle which absorbs the radiant energy, and the infrared emitter members are located equally distanced on the inner surface wall, facing the center of the cylindrical container, and;
f) as part of the fast energy density increasing means, said cylindrical container volume is located outside and above the molten salt (TES) tank, and of the total heat transfer section about 65 percent of the working gas pipe section in terms of external surface heat conduction area circulate within the (TES), and about 35 percent of the working gas pipe that is in the form of a spiral pipe section by external surface radiant energy absorption area, is located within the center of the energy density increasing cylindrical volume, and;
g) as part of the secondary backup means; the surface with high infrared radiation absorption rate concentric ring section is located below the (TES) bottom area, to absorb infrared radiation input with regular short intervals from another set of radiation emitters providing secondary infrared radiation energy, where the concentric ring surface acts as the thermo-dynamic energy input surface, applied only after the (TES) total kinetic energy has already been stabilized by the main means first, and;
h) said molten salt containing section of the (TES) volume cylindrical container has at least an inlet-filling and a drainage outlet pipe utilizing either molten salt with non-corrosive additives or a high temperature durable oil based medium and provides the means for changing one medium with different specifications that can be utilized by interchanging the different mediums, as well as for changing the same type of medium for the periodic maintenance, top side frame has a secure and tight closure to enable access into the (TES), and the energy density increasing means horizontal cylindrical container volume has also a small secure door to enable access to the container volume therein for maintenance, and repair, and;
i) at least two steam turbines-generators connected to above mentioned spiral working gas pipe that becomes a linear pipe exiting the (TES,) and;
j) at least a service hot-water tank located against the external surface area of the frame wall of the (TES) container that covers around the one-half the circumference of the (TES) volume cylindrical external surface area of the said frame for waste heat utilization there-from; and provides water heating that is based on a year round load averaged over 24 to 48 hour period and delivers a pre-selected 55-70 degrees Centigrade to a hot water output, like a shower, dishwasher, washing machine, other appliances, and;
k) a hot oil tank with at least 70 degrees Centigrade stabilized and sustainable oil temperature that contains the refrigerant coils circulating therein; and likewise is located against the external surface area of the wall of the (TES) container and covers around the other ½ circumference of the (TES) volume cylindrical external surface area of said frame; for waste heat utilization from the (TES) and for the refrigeration cycle which provides chilled water to the chilled water unit for central air conditioning, and;
l) at least a series of first option hot water based radiators connected to the working gas pipe for central heating means that are located within residential and/or commercial buildings or;
m) as an alternative to above mentioned hot water based radiator residential central heating, at least one heat exchanger and hydronic coils and all forced air related devices and mechanisms for central forced air heating, and;
n) as part of the second embodiment; modularly integrated and higher capacity (TES) units making up larger, higher capacity plants of up to 15 MW, and;
o) an enclosure that makes the sections mentioned above in; a, b, c, d, e, f and g, accessible to expert company maintenance personnel only.

2. The system of claim 1, wherein the secondary backup means is always ready to backup the system, thereby; the system becomes a securely backed up system, a possibility of a weak link-component in the system of the main radiant energy means that could make the entire system dysfunctional is avoided, if the main means becomes dysfunctional for some reason, the secondary means gets functional and both are mutually independent of each other in terms of the energy input control board of the electrical source and circuitry connection and different and independently located heat conduction areas below the same (TES,) this enables the secondary backup means to be the single main means of the system on a temporary basis for long periods, during maintenance of the main means, and if it fails and it is being repaired, and when parts are changed.

3. The system of claim 1, wherein the main energy generation means of the infrared radiation members and the fast energy density increasing means within the horizontal cylindrical container, as well as the secondary backup means with the circular infrared emitters below the (TES); all preferably receive a low cost operational energy input from an origin of a renewable prime energy source of solar or wind energy which gets leveraged by this innovation system in time, and to secure an uninterrupted operational energy input;
a) the main infrared radiation means members, the fast energy density increasing means and the secondary backup means are also coupled to the utility grid for the operational energy input and switch temporarily to utility grid power input mode, when the renewable prime means energy source of solar or wind energy input gets insufficient due to becalmed wind for days or because of insufficient solar radiation temporarily, and;
b) the steam turbine-generators of the system have the means to operate in parallel with the utility grid; and the electricity generated can be sold on a contract basis to users outside of the host facility; since the system satisfies the qualify facility (QF) status based on the following requirement given by the seventh original and following derived eighth equation, the original requirement being:
Power output+one-half Useful thermal output/Energy input>42.5 percent (in a year) (7); and
for the invention system the above seventh equation reads instead as the eighth equation: Power output+½ Useful thermal output/Energy input>59 percent (in a year) (8);
therefore the invention system far exceeds this basic requirement, and;
c) said renewable energy source for the 100 percent renewable operational energy input configuration can be existing wind farms and does not involve high economic, externality and opportunity costs as in other systems, as in combustion plants subject to scarcity of carbon fuels, unstable fuel prices and high pollution prevention costs, investment in fuel gathering and storage equipment, since the energy source for this innovation is a substantially smaller and lower cost wind turbines installation, or a new small installation integrated to the system; hence, only a fraction of the number of wind turbines, as compared to a full scale large wind farm and full scale solar panel units, suffice for the operational input energy and thereby avoids high opportunity costs and reduces the cost factor of land, as a result the ratio of land-space utilization in square meters or cubic meters to the energy generated in kW or MW is reduced substantially and;
d) the system is able to generate the same amount of power per a given time period as a full scale large wind farm or a full scale solar panel units installation, by accumulating thermo-dynamic energy within the (TES) regularly and efficiently, thereby leveraging operational energy input by utilizing steam power and thermo-dynamic energy efficiently, when the central heating and air conditioning are also accounted for in the long run, wherein the (TES) has the ability to spread power generation and central heating, air conditioning in time based on peak demand and optimization based on all different levels of demand variations, and;
e) with this innovation system, for both wind and solar, the renewable energy surplus output when winds are at highest speeds and solar radiation conditions are at the highest; most of this large energy surplus gets stored within the (TES) with high efficiency, and;
f) when the input energy source is from a source like another conventional type of power plant—in which case the invention system functions as an auxiliary power output booster system within the power plant complex and within other types of power plants, the energy input gets leveraged by the high efficiency infrared radiation periodic energy input and the high efficiency, high density total kinetic energy stabilized (TES) synergy of this system, and;
g) as a result of a highly stabilized total kinetic and average kinetic energy (TES) with high specific heat capacity therein, the leverage on operational energy input in terms of the energy input versus usable net energy output within a certain period in terms of cent/kWh of energy output provided by any type of operational input energy cost gets reduced and makes the invention system feasible for long term efficient operation, and in terms of cent/kWh of energy output provided, the operational input energy cost becomes the lowest cost input possible, especially as the preferred low cost renewable prime energy; wind is utilized for the operational energy input.

4. The system of claim 1, wherein the relatively low cost synergistic combination of different means retrofits to the existing manufacturing technology and the existing means of related industries and therefore has a shorter system construction time, substantially lower capital intensity and a flexible manufacturing method of coordinated modular design, high rate of modularity and assembly provides high flexibility and a wide range of scaling and a wide range of different capacities, where components of the system can be procured by the manufacturer, investing-organizing company or partners, sub-contractor companies from one or several different manufacturers with established economies of scale; thereby enables;
a) to retrofit to existing similar means of manufacturing technologies, molding means and apparatus, on the existing lines of manufacturing that already have a certain level of economies of scale for most of the system components; by modular integration of components needed, as opposed to investing in new manufacturing lines, and;
b) to have a system that is overall less complicated and is a compact cogeneration system as compared to comparable capacity systems, and has the flexibility to be a modularly integrated higher capacity system, by integrating two, four, six, or more modular (TES) units, or as one large (TES) unit, increasing the capacity, wherein the system does not have moving components, burners, combustion chambers and hence no exhaust control devices as part of the main means, therefore, enables lower initial investment cost, shorter time to reach the base load and peak load operation conditions and the most efficient long term system capacity utilization within a substantially shorter power load period as compared to other comparable capacity cogeneration systems; therefore provides a return on investment (ROI) of at least three to five years earlier, along with higher operational profits advantage and a very competitive turnkey construction cost ($/kWh,) and;
c) an investment with substantially lower initial capital intensity possible due to a compact and well insulated transmission and distribution system and relative ease of tooling, lower material cost, ease of assembly of modular parts, and high reliability, availability, maintainability and durability which reduces product life-cycle costs in comparison to comparable capacity systems and hence which would enable high profit rates on system sales and high profit rates on leases, and the company having the rights on the system would reserve the rights to make lease or sales contracts to maximize profits, and;
d) since there is no central heating demand during summer, most of the working gas would be available for the generation of power, thereby electricity can be sold on a contract basis to users outside of host facility, while completely satisfying the central air conditioning for even the peak load air conditioning needs very efficiently; whereas the prior art air conditioning system at peak load consumes great amounts of electricity, with this invention system electricity is not converted back to a thermal process, therefore; the system can be utilized throughout all seasons very efficiently.

5. The system of claim 2, outside the perimeters of said central part of the (TES) bottom and of said radiation area upper surface of the ideal blackbody approximating container, is the separate and independent infrared-high absorption concentric ring area below the (TES,) thereby:
a) the infrared-high absorption backup concentric ring area, that is located outside and around the main means surface area gets functional only when main means is interrupted or is under maintenance, and;
b) wherein said infrared radiant energy receiving surface section is located at the bottom of the (TES) as a concentric ring surface, surrounding the main means which establishes a base load temperature range located centrally below the (TES,) during the maintenance or failure of this main infrared thermo-dynamic energy input means; as a secondary backup infrared radiation means, thereby a secure back up power supply system is provided, and;
c) the efficiency of the secondary backup means infrared radiation thermo-dynamic energy input through the high absorption rate concentric ring area means, stems from the fact that this infrared radiation energy input means is activated for shorter intervals and only after the (TES) total kinetic energy has been stabilized by the main radiant energy means initially.

6. The system of claim 1, wherein the cylindrical container is a horizontally positioned and externally located cylindrical container member, which contains infrared radiation emitters internally and is related to the fast energy density increasing means, which has the following technical means and consists of:
a) at least one cylindrical container located outside and above the hot molten salt (TES,) which has air as the medium and has a reflective internal surface and this enables to focus the infrared radiation energy input directly onto the working gas spiral pipe with a long high radiant energy absorption painted pipe section therein at the center, which enables to increase the energy density of the working gas swiftly, and;
b) flow control and regulation devices are regulated such that about 70 percent of the working gas volume per cycle passes through the spiral pipe section within the cylindrical container energy density increasing means arrives at 500 degrees Centigrade, and only about 30 percent of the total working gas volume circulating within the spiral pipe section per cycle arrives at a lower threshold of 350 degrees Centigrade when system is at base load, and when heating and power demands are at the peak levels for a long time, about 55 percent of the working gas can arrive at 350 degrees Centigrade and the system can be regulated to raise 55 percent of the working gas to 550 degrees Centigrade quickly for the very high and persistent demand, and;
c) said cylindrical container volume contains the internal infrared radiation energy emitters, placed at equal distances from each other internally within the cylindrical container wall, all facing the spiral pipe which is centrally located along the horizontal length of the cylindrical container within, with at least four emitters located on the internal surface of the cylindrical container, where these radiation emitting members are directed onto the spiral pipe, this enables radiation from a set of four different directions and angles that avoids radiation interference between any two emitters and maximizes the surrounding effect and focuses radiant energy along the spiral section at the center of the container, and;
d) working gas flow speed regulator and temperature sensors; assist in increasing the energy density and a fast rise in average kinetic energy for the working gas, an increase in temperature at a range of 200-250 degrees Centigrade, for only about 30 percent of the total working gas volume per cycle, enhances the existing thermo-dynamic energy of the working gas that comes out of the (TES) at about 350 degrees Centigrade prior entering into the fast energy density increasing cylindrical container, hence is highly energy efficient, as it takes less, short durations of radiation input to increase the average kinetic energy of only 30 percent of the working gas, and;
e) temperature sensors on working gas pipe at the fast energy density increasing cylindrical container entry and exit points; while 70 percent of the working gas volume per cycle passes through at a range of 500-550 degrees Centigrade, the fast energy density increasing infrared radiation input is not activated, it is activated only when the working gas arrives at about 350 degrees Centigrade, when activated, the working gas swiftly attains steam temperature range of 500-550 degrees Centigrade and a range of 500-600 degrees Centigrade for the second embodiment, this provides immediate and energy efficient rise in average kinetic energy to obtain superheated steam within spiral pipe, and the combined effect of the stable (TES) and the fast energy density increasing means enables high efficiency shorter power load period and faster capacity utilization as compared to other power plants of comparable capacity, and;
f) at least one tamper proof closure that is related to this section that can be opened only by the authorized company personnel.

7. The system of claim 1, wherein said molten salt containing cylindrical (TES) container external side surface area of the (TES) volume communicates waste heat into:
a) the service hot water tank, that is around the one-half of the circumference of the (TES) volume metal cylinder frame, as well as into;
b) the oil tank that contains the refrigerant coils circulating therein, located around the other one-half circumference of the (TES) volume cylindrical structure side walls, with a refrigerant circulation hot working gas coil section that circulates within the oil tank volume where said oil tank faces the other one half circumference of the (TES) molten salt volume external wall cylindrical surface area to utilize the waste heat thereof, to heat up the refrigerant gas therein and provides a refrigeration cycle to provide cooling for a chilled-water based central air conditioning during summer, and;
c) further comprises a heat conduction semi-insulation layer that conducts waste heat at a certain limited rate, such that the rate of waste heat conducted is a function of the rate of heat conductivity of the semi-insulator, which is located in between the said service hot water tank and said oil tank internal surface wall that faces the (TES) volume cylindrical external wall, and covers the entire circumference of the wall of the cylindrical frame of the (TES) volume for desired level, limited heat conduction means.

8. The system of claim 1, wherein the energy input that is through the main infrared radiation means has at least 90 percent efficiency in terms of converting operational electrical power input to radiant energy.

9. A method of generating thermo-dynamic energy and another means that enhances and increases the energy density of the energy input provided by the main infrared radiation means quickly; applied to the (TES) bottom, a synergy of one main means and the fast energy density increasing means combination, and the secondary backup means which makes the system a high reliability system, for both first and second embodiments comprise the steps of:
a) receiving regularly repeated thermo-dynamic energy from said infrared radiation through the radiation area, with at least one (TES,) and when more units of modularly increasing the system in number of (TES) units is applied (as in FIG. 9,) in order to provide thermo-dynamic energy into corresponding number of adjacent molten salt (TES) volumes total kinetic energy reservoirs located above said radiation areas by using the radiant energy absorbing and emitting blackbody containers which emit thermo-dynamic energy into the (TES,) that establish highly total kinetic energy and total average energy stable volumes of (TES) molten salt, and;
b) circulating the working gas within the (TES) molten salt volume containing the circular pipe that contains the working gas pipe section and transferring said high pressure working gas with about 1500 psig—and a certain section which is located within the energy density increasing cylindrical container volume, within which the energy density increases in a relatively small focused volume of spiral pipe section in a very short time, and then passing the working gas in a topping cycle through steam turbines and then through a closed cycle working gas pipe that is connected to radiators or air handlers, with a flexible allocation means of steam power for the power generation turbines, and;
c) circulating the working gas for central heating within a transmission and distribution system that has very strong insulation and that is optimal and compact in terms of capacity and the residential area covered, which thereby meets the objective of the high load density; and therefore would cover the capital investment of the transmission and distribution system to establish an optimal balance between power generation and heating needs, and;
d) utilizing the infrared radiant energy and optional high absorption backup concentric ring thermo-dynamic energy input means through the bottom of the molten salt (TES); to back up the main means of infrared radiation thermo-dynamic input, to be utilized as the single main means temporarily, if the main radiation means fails or is under maintenance, and;
e) increasing the energy density quickly within at least one cylindrical container which is located outside the molten salt (TES,) with infrared radiation emitting gear therein, placed on the internal surfaces of the cylindrical container walls and facing-directed to the center of the cylindrical container—where this infrared radiation is directed onto the working gas pipe, from at least four different directions with ninety degrees difference between at least all four radiation emission angles, along the path of and directed to the spiral pipe, thereby radiation interference between two emitters is eliminated, this also enables a quick temperature increasing means and provides the means of a relatively small volume in which the energy density can be increased very efficiently and quickly as the working gas passes this section.

10. The system of claim 1, further provides a second embodiment of modularly integrated and larger-higher capacity cylindrical (TES) units, alternatively as single high capacity (TES) unit, and the choice would be based on site specific needs, for a higher capacity plant with a capacity of up to 15 MW capacity; that provides electrical energy and high temperature steam which operates on a combined mode utilization of both the electricity generated at a very low cost of about two cents/kWh and efficient central heating, excluding tax incentives and investment subsidies, and utilization of low cost electricity and steam is to provide:
a) onsite residential and industrial electrical power and central heating, which thereby also increases the resiliency of the national energy infrastructure by avoiding transmission losses and limiting congestion, by contributing to a higher national CHP generation rate and;
b) electrical power for electric vehicles transportation; by providing electrical power supply of the integrated modularly increased capacity plant with a high capacity of up to 15 MW to be the reliable and the lowest cost electrical power source available for industrial scale electric automobile (EV) battery charging and exchanging stations infrastructure called; Project Better Place which is developed by the Nissan-Renault alliance and for other automotive brands accepting the same system and;
c) thermo-dynamic and electrical energy for various process heat applications.

11. The method of claim 9, wherein the step of placing at least a set of infrared radiation gear combination with the operational electrical energy input, in communication with said infrared radiation emitters further comprises using operational energy input as the first preferred source from a renewable prime energy source such as wind or solar, as a low cost electrical energy input, but can also get electrical input from the utility grid, where emitters provide high efficiency infrared radiation periodically.

12. The method of claim 9, further comprising the step of periodically providing infrared radiation with lower energy input phase first to draw less energy and to avoid thermal stress at start up, which is repeated later regularly as the system operates at base load, and which has a longer interval than a full on interval, and hence lower operating temperature ranges and lower energy consumption in the long run, with on and off intervals in between; therefore the utilization of the operational input energy is spread in time most efficiently, while it keeps the total kinetic energy of the (TES) stable, by:
a) comprising the step of repeating the cycles at certain regulated and adjustable intervals, which are under the control and regulation of the computer for the base load, peak load and for all different load levels and is operated by a fully electronic, computerized and direct digital control (DDC) system combination, and;
b) said computerized and (DDC) system monitors and controls mainly the conditions of; the temperature and pressure in volumes such as the temperature stabilization of the (TES) molten salt volume, temperature and pressure of working gas in the energy density increasing spiral pipe section, and;
c) the frequency of said infrared radiation is regulated by the; while do close under the fourth algorithm, which regulates radiation temperature which in turn enables the frequency and radiation ratio to be reduced in the long run, as the base load condition and high efficiency capacity utilization levels are achieved, increasing the efficiency by optimal utilization of energy input as a result of the decreased frequency and lower radiation ratio of infrared radiation energy input to optimized lower frequencies and ratios in the long run.

13. The method of claim 12, wherein the desired base load temperature of the said molten salt (TES) is in the sustainable and stabilized temperature range of 400-550 degrees Centigrade, in which at least 350 degrees Centigrade is the lowest threshold temperature of the molten salt of the (TES,) which enables the specific heat capacity related thermo-dynamic total kinetic energy level to become highly stable and be kept within a narrow desired temperature range; while above this threshold, requires only regular short intervals of operational energy input that can be utilized with high efficiency.

14. The methods and system of claim 9 or 10, wherein the step of emitting thermo-dynamic energy can have two different embodiments; wherein the temperature and energy generation capacity ranges are different as follows:
a) for the first embodiment, thermo-dynamic energy from said repeated radiation and the blackbody container upper surface of at least one unit at the range of 300-650 degrees Centigrade infrared radiation utilizes the infrared energy input; wherein the main means is the infrared radiant energy, and the closed container approximates the blackbody container condition therein with thermo-dynamic energy absorbing and emitting surfaces, resulting in a (TES) molten salt volume with a stabilized temperature of at least 500 degrees Centigrade at base load, along with the cylindrical container volume of the fast energy density increasing means that acts on the working gas spiral pipe section therein with high energy efficiency, and;
b) for the second embodiment, thermo-dynamic energy from said periodically repeated infrared radiation, the blackbody container upper surface emits energy at the range of 300-650 degrees Centigrade and increases the temperature range of said (TES) volume containing the molten salt, to establish a stabilized higher temperature, that is higher by at least 100 degrees Centigrade than the first embodiment at base load, where the number of units can be increased modularly, and by increasing the (TES) capacity; and therefore the system working gas capacity is increased for the second embodiment, making higher temperatures and higher pressure steam available for generating electricity at a very low cost, and;
c) where the cogeneration constant can be used to determine the rate of useful thermal energy and to make comparisons of thermal versus electrical of end needs, in therms/hour or in MW (e) respectively, given by the following ninth equation:
Q=E×Kc (9);
where E is the cogeneration system electrical rated capacity, Kc the cogeneration constant, and;
d) in both embodiments, higher efficiency by reaching higher temperatures provided by repeated infrared radiation intervals is made possible by the high stability molten salt (TES) temperature, wherein each of the next radiation interval starts with a higher temperature (TES) than before, as power gets loaded, thereby the radiation temperature of the infrared radiant energy means can be gradually reduced in time, as higher total kinetic energy stability within the molten salt (TES) gets established and therefore; the frequency and radiation intensity ratio can be regulated and reduced for long term higher efficiency.

15. The method of claim 9 or 14, wherein the step of providing infrared radiation at a range of 300-650 degrees Centigrade, results in an efficient radiation input energy; with a lower frequency of radiation and radiation intensity ratios, at the lower bounds at about 300-350 degrees Centigrade, instead of the maximum 650 degrees Centigrade, once the (TES) gets stabilized at the desired temperature range.

16. The system of claim 1, wherein the infrared radiant energy means and the energy density increasing means with the infrared radiation thermo-dynamic input is directly applied on the spiral working gas pipe section; enhancing the high stability (TES) volume with high input energy efficiency, and generates superheated steam and thereby enables:
a) the system; both the small and large capacity embodiments to be an onsite energy provider system that enables customization for owners particular facilities, which can be independent of the central utility grid, and for the larger capacity second embodiment, it can be part of the main grid and can be utilized as an auxiliary power output enhancement system within other power plant facilities like nuclear reactor power plants, coal power plants, and natural gas power plants, and;
b) the system to be integrated with process heat applications such as chemical, paper and food plants, and industrial scale hydrogen manufacturing industry utilizing the low cost electricity of the invention system by applying electrolysis, and desiccant dehumidification for refrigerated warehouses, supermarkets, ice rinks and hospitals; which can be utilized when integrated to the system along with proper heat exchangers and utilize directly the (TES) volume thermo-dynamic energy, the electricity and steam generation means of the invention system, and;
c) the system to be a zero emission, zero thermal pollution system; since there is no combustion, no exhaust and therefore zero exhaust heat loss, therefore in addition to the energy efficiency benefits, this cogeneration system is compatible with the 350 ppm CO2 objective as a zero emission system and qualifies for the environmental permitting and is also ideal for international greenhouse gases trading scheme-providing additional financial returns to the operators and end users, and;
d) to have a compact and lower total weight system in comparison to prior art cogeneration systems of comparable capacity for both of the embodiments, and;
e) the system to be operable without vibration and which is very silent, and;
f) a fully secure control system against overheating and related accidents.

17. The system of claim 1, wherein the cogeneration system capacities can be within a very broad range; it can be in the range of 300 kW or greater capacity compact onsite small system for a group of buildings, a group of office buildings, a smaller system in commercial or navy ships or the system can have a large capacity; of up to 15 MW capacity power plant by increasing the number of infrared radiation emitters and the infrared energy providers and by increasing (TES) unit volume capacities and the number of (TES) units by two, four and by increments of two units for higher total capacity integrations of the molten salt (TES) units modularly, and by increasing the capacity of the fast energy density increasing means unit proportionally, thereby the system can be applied as a cogeneration system for large commercial complex buildings, a larger group of residential buildings, military installations, hospitals and campuses and can also be able to sell surplus energy to the utility grid.

18. The system and method of claim 1 or 9, wherein the feature of increasing the energy density of the system provides a fast and efficient energy density increasing means by utilizing the periodic infrared radiation within said cylindrical section with the high absorption rate coating spiral pipe section therein, this means of the innovation system solves a specific problem unique to renewable energy systems, specifically:
a) low energy density of renewable energy systems relative to combustion based systems, combustion based systems having higher energy densities; with said fast and efficient energy density increasing means by the infrared radiation energy within cylindrical container and the spiral pipe section therein, the energy density of this non-combustion, zero emission system becomes comparable in energy density level to combustion based systems, and;
b) the efficiency of this energy density increasing means is higher in energy efficiency than the energy efficiency of the state of the art combustion based systems.

19. The system of claim 1, wherein the technical details of the system are kept secret and to make reverse engineering impossible, the technical details of the main critical system features of at least; the circular structure holding the infrared radiation emitter members with air inflow grids below, the infrared radiation application volume, the container that closely approximates an ideal blackbody condition therein, the cylindrical container fast energy density increasing means, and the (TES) volume, all of these sections are kept secret and made accessible to only expert company maintenance personnel and are made tamper proof and inaccessible to others by containing these in proper locked up tamper proof enclosures and locked closures, of which entry points are under camera surveillance, and even if the camera surveillance gets disabled and if the system gets tampered with, an immediate alarm gets out directly to the nearest security personnel, to the onsite operators and to the nearest operating company offices via phone lines and the computer connection, showing the specific site where tampering is attempted.
